(19) United States
(12) Patent Application Publication
(10) Pub. No.: US 2021/0277894 A1
(43) Pub. Date: Sep. 9, 2021

(54) PUMP DEVICE

(71) Applicant: Nidec Tosok Corporation, Zama-shi, Kanagawa (JP)

(72) Inventors: Kazuhiro HOMMA, Zama-shi (JP); Yosuke ITO, Zama-shi (JP)

(21) Appl. No.: 16/334,385

(22) PCT Filed: Sep. 25, 2017
(86) PCT No.: PCT/JP2017/034550

§ 371 Date: Mar. 19, 2019

(30) Foreign Application Priority Data
Sep. 30, 2016 (JP) 2016-195276

(51) Int. Cl. F04C 15/06; F04C 2/10; H02K 9/19; H02K 16/02

(52) U.S. Cl. CPC F04C 15/06; H02K 16/02; H02K 9/19; F04C 2/10

(57) ABSTRACT

A pump device includes a shaft , a motor unit that rotates the shaft, and a pump driven by the motor via the shaft and discharges oil. The pump device includes a first flow path for the oil that connects the inside of the pump and the inside of a housing, a second flow path for the oil provided between a stator and a rotor, and a third flow path for the oil that is connected to a suction port of a pump through the outside of the stator and the rotor in a radial direction from the second flow path. One or a plurality of grooves are provided on the outer peripheral surface of the rotor or the inner peripheral surface of the stator, and the groove is inclined with respect to an oil flow direction.

### TECHNICAL FIELD

The present disclosure relates to a pump device.

### BACKGROUND ART

In recent years, responsiveness has been required for electric oil pumps used for a transmission and the like. In order to realize responsiveness in an electric oil pump, it is necessary for an electric oil pump motor to have a high output.

When an electric oil pump motor is made to have a high output, a large current flows through a coil included in the motor, the temperature of the motor becomes high, and, for example, a permanent magnet included in the motor may be demagnetized. Therefore, in order to prevent the temperature of the motor from increasing, it is necessary to provide a cooling structure in the motor.

Japanese Unexamined Patent Application Publication No. 2008-125235 discloses an electric motor having an oil supply mechanism that displaces a relative positional relationship between a stator and a rotor in an axial direction with a hydraulic pressure of oil according to a rotational speed of a rotor and thereby cools the rotor with oil.

However, in the electric motor disclosed in Japanese Unexamined Patent Application Publication No. 2008-125235, it is not possible to cool the stator and the rotor with oil at the same time.

### SUMMARY OF THE DISCLOSURE

Example embodiments of the present disclosure provide pump devices each having a structure that achieves an excellent cooling effect in which a stator and a rotor are cooled at the same time.

An example embodiment of the present disclosure provides a pump device including a shaft that rotates around a central axis that extends in an axial direction, a motor that rotates the shaft, and a pump that is positioned on one side of the motor in the axial direction, is driven by the motor via the shaft, and discharges oil, wherein the motor includes a rotor that rotates around the shaft, a stator that is disposed to face the rotor, and a housing in which the rotor and the stator are accommodated, wherein the pump includes a pump rotor that is attached to the shaft, and a pump case in which a suction port into which the oil is sucked and a discharge port from which the oil is discharged are provided and the pump rotor is accommodated, wherein the pump device includes a first flow path for the oil that connects the inside of the pump and the inside of the housing, a second flow path for the oil provided between the stator and the rotor, and a third flow path for the oil that is connected to a pump suction port through the outside of the stator and the rotor in a radial direction from the second flow path, wherein one or a plurality of grooves are provided on the inner peripheral surface of the rotor and the stator disposed in a radially outward direction or on the outer peripheral surface of the rotor and the stator disposed in a radially inward direction, and the groove is inclined with respect to the oil flow direction.

According to an example embodiment of the present disclosure, it is possible to provide a pump device with a structure that achieves an excellent cooling effect in which the stator and the rotor are cooled at the same time.

The above and other elements, features, steps, characteristics and advantages of the present disclosure will become more apparent from the following detailed description of example embodiments with reference to the attached drawings.

### BRIEF DESCRIPTION OF THE DRAWINGS

FIG. 1 is a cross-sectional view showing a pump device according to a first example embodiment of the present disclosure.

FIG. 2 is a diagram schematically showing elements of the pump device according to the first example embodiment of the present disclosure.

FIG. 3A is a diagram showing the shape of a groove of a stator or a rotor.

FIG. 3B is a diagram showing the shape of a groove of a stator or a rotor.

FIG. 3C is a diagram showing the shape of a groove of a stator or a rotor.

FIG. 3D is a diagram showing the shape of a groove of a stator or a rotor.

FIG. 3E is a diagram showing the shape of a groove of a stator or a rotor.

FIG. 4 is a top view of the stator in the first example embodiment of the present disclosure.

FIG. 5A is an enlarged view of a portion of flow path in the first example embodiment of the present disclosure.

FIG. 5B is an enlarged view of a portion of a flow path in the first example embodiment of the present disclosure.

FIG. 6 is a diagram showing a modified example of the flow path in the first example embodiment of the present disclosure.

FIG. 7 is a cross-sectional view showing a pump device according to a second example embodiment of the present disclosure.

FIG. 8 is a cross-sectional view showing a pump device according to a third example embodiment of the present disclosure.

FIG. 9 is a cross-sectional view showing a modified example of the pump device according to the third example embodiment of the present disclosure.

### DETAILED DESCRIPTION OF EXAMPLE EMBODIMENTS

Pump devices according to example embodiments of the present disclosure will be described below with reference to the drawings. Here, the scope of the present disclosure is not limited to the following example embodiments, and can be arbitrarily changed within the spirit and scope of the present disclosure. In addition, in the following drawings, in order to allow respective configurations to be easily understood, the sizes and numbers in the structures may be different those in actual structures.

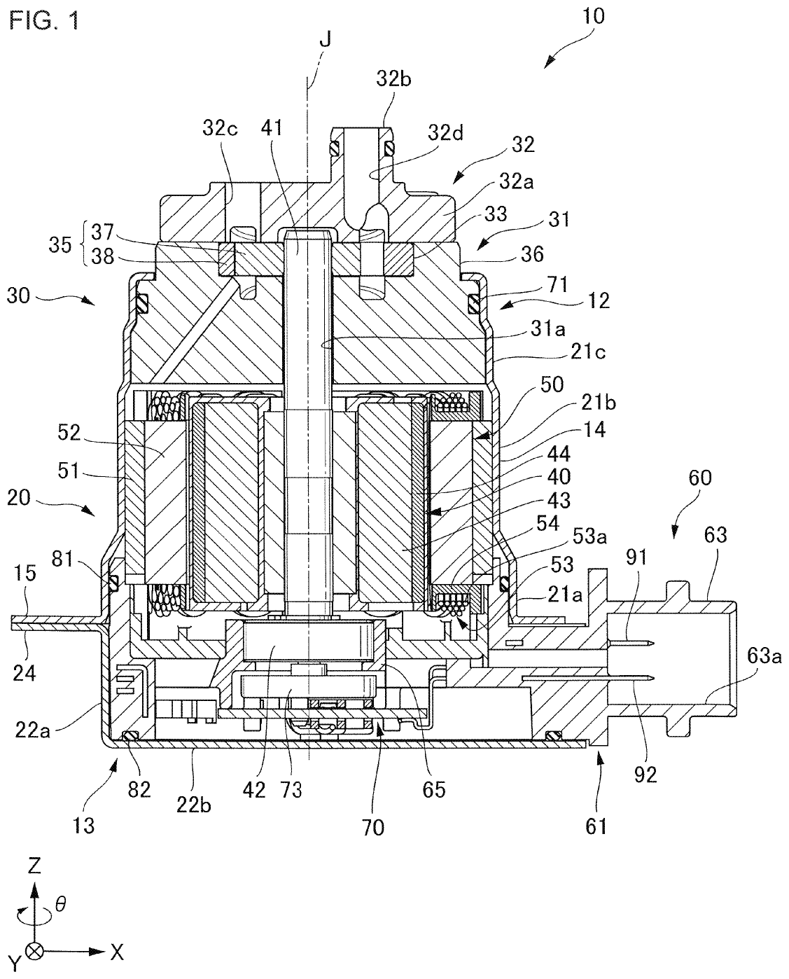

In addition, in the drawings, an XYZ coordinate system is appropriately shown as a three-dimensional orthogonal coordinate system. In the XYZ coordinate system, the Z axis direction is a direction parallel to one axial direction with respect to a central axis J shown in FIG. 1. The X axis direction is a direction parallel to a lengthwise direction of a bus bar assembly 60 shown in FIG. 1, that is, the left to right direction in FIG. 1. The Y axis direction is a direction parallel to a width direction of the bus bar assembly 60, that is, a direction orthogonal to both the X axis direction and the Z axis direction.

In addition, in the following description, the positive side (+Z side) in the Z axis direction will be referred to as “front side” and the negative side (−Z side) in the Z axis direction will be referred to as “rear side.” Here, the rear side and the front side are terms that are simply used for explanation, and do not limit actual positional relationships and directions. In addition, unless otherwise noted, a direction (Z axis direction) parallel to the central axis J is simply defined as an “axial direction,” a radial direction with respect to the central axis J is simply defined as a “radial direction,” and a circumferential direction with respect to the central axis J, that is, a circumference (θ direction) around the central axis J is simply defined as a “circumferential direction.”

Here, in this specification, the term “extending in the axial direction” includes not only extending strictly in the axial direction (Z axis direction) but also extending in a direction inclined in a range of less than 45° with respect to the axial direction. In addition, in this specification, the term “extending in the radial direction” includes not only extending strictly in the radial direction, that is, extending in a direction perpendicular to the axial direction (Z axis direction), but also extending in a direction inclined in a range of less than 45° with respect to the radial direction.

### First Example Embodiment

FIG. 1 is a cross-sectional view showing a pump device 10 of the present example embodiment.

The pump device 10 of the present example embodiment includes a shaft 41, a motor unit 20, a housing 12, a cover 13, and a pump unit 30. The shaft 41 rotates around the central axis J that extends in the axial direction. The motor unit 20 and the pump unit 30 are provided in the axial direction side by side.

As shown in FIG. 1, the motor unit 20 includes the cover 13, a rotor 40, a stator 50, a bearing 42, a control device 70, the bus bar assembly 60, and a plurality of O-rings. The plurality of O-rings include a front side O-ring 81 and a rear side O-ring 82.

The rotor 40 is fixed to the outer peripheral surface of the shaft 41. The stator 50 is positioned radially outward from the rotor 40. That is, the motor unit 20 is an inner rotor type motor. The bearing 42 rotatably supports the shaft 41. The bearing 42 is held by the bus bar assembly 60. The bus bar assembly 60 is connected to an external power supply and supplies a current to the stator 50.

The housing 12 holds the motor unit 20 and the pump unit 30. The housing 12 opens to the rear side (−Z side), and the front side (+Z side) end of the bus bar assembly 60 is inserted into an opening of the housing 12. The cover 13 is fixed to the rear side of the housing 12. The cover 13 covers the rear side of the motor unit 20. That is, the cover 13 covers at least a part of the rear side (−Z side) of the bus bar assembly 60 and is fixed to the housing 12.

The control device 70 is disposed between the bearing 42 and the cover 13. The front side O-ring 81 is provided between the bus bar assembly 60 and the housing 12. The rear side O-ring 82 is provided between the bus bar assembly 60 and the cover 13. Hereinafter, respective components will be described in detail.

### <Housing>

As shown in FIG. 1, the housing 12 has a tubular shape. More specifically, the housing 12 has a multi-stage cylindrical shape of which both ends around the central axis J are open. The material of the housing 12 is, for example, a metal. The housing 12 holds the motor unit 20 and the pump unit 30. The housing 12 has a cylindrical part 14 and a flange part 15.

The flange part 15 extends radially outward from the rear side end of the cylindrical part 14. The cylindrical part 14 has a cylindrical shape around the central axis J. The cylindrical part 14 has a bus bar assembly insertion part 21a, a stator holding part 21b, and a pump body holding part 21c in the axial direction (Z axis direction) from the rear side (−Z side) to the front side (+Z side) in this order.

The bus bar assembly insertion part 21a surrounds the front side (+Z side) end of the bus bar assembly 60 from the outer side in the radial direction of the central axis J. The bus bar assembly insertion part 21a, the stator holding part 21b, and the pump body holding part 21c have concentric cylindrical shapes, and their diameters decrease in this order.

That is, the front side end of the bus bar assembly 60 is positioned inside the housing 12. The outer surface of the stator 50, that is, the outer surface of a core back part 51 to be described below, is fitted to the inner surface of the stator holding part 21b. Accordingly, the stator 50 is held in the housing 12. The outer peripheral surface of a pump body 31 is fixed to the inner peripheral surface of the pump body holding part 21c.

### <Rotor>

The rotor 40 has a rotor core 43 and a rotor magnet 44. The rotor core 43 surrounds the shaft 41 around the axis (θ direction) and is fixed to the shaft 41. The rotor magnet 44 is fixed to the outer surface along the axis of the rotor core 43. The rotor core 43 and the rotor magnet 44 rotate together with the shaft 41.

### <Stator>

The stator 50 surrounds the rotor 40 around the axis (0 direction) and rotates the rotor 40 around the central axis J. The stator 50 includes the core back part 51, a tooth part 52, a coil 53, and a bobbin (insulator) 54. The shape of the core back part 51 has a cylindrical shape concentric with the shaft 41.

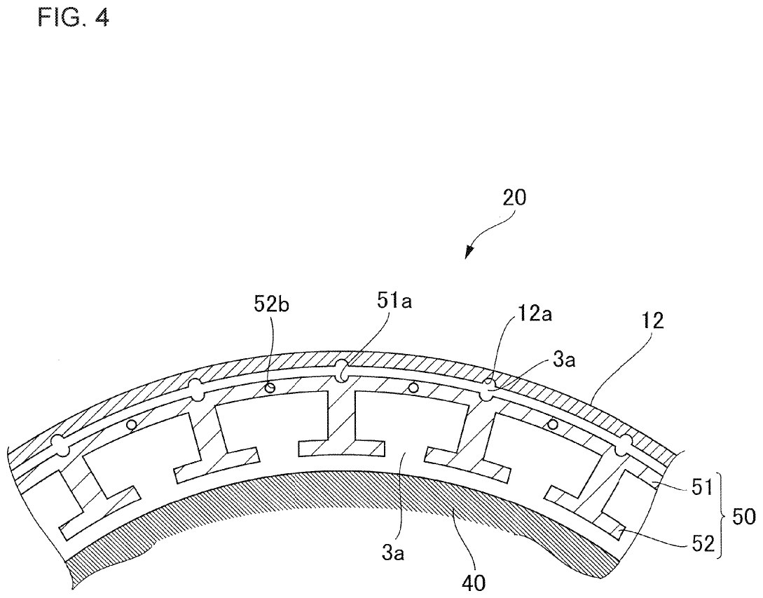

The tooth part 52 extends from the inner surface of the core back part 51 toward the shaft 41. A plurality of tooth parts are provided and are disposed at equal intervals in the circumferential direction of the inner surface of the core back part 51 (FIG. 4). The coil 53 is formed by winding a conductive wire 53a. The coil 53 is provided on the bobbin (insulator) 54. The bobbin (insulator) 54 is attached to each of the tooth parts 52.

### <Bearing>

The bearing 42 is disposed on the rear side (−Z side) of the stator 50. The bearing 42 is held by a bearing holding part 65 of a bus bar holder 61 to be described below. The bearing 42 supports the shaft 41. The configuration of the bearing 42 is not particularly limited, and any known bearing may be used.

<Control device>

The control device 70 controls driving of the motor unit 20. The control device 70 includes a circuit board (not shown), a rotation sensor (not shown), a sensor magnet holding member (not shown), and a sensor magnet 73. That is, the motor unit 20 includes the circuit board, the rotation sensor, the sensor magnet holding member, and the sensor magnet 73.

The circuit board outputs a motor driving signal. The sensor magnet holding member is positioned by fitting the center hole to a small diameter part of the rear side (+Z side) end of the shaft 41. The sensor magnet holding member is rotatable together with the shaft 41. The sensor magnet 73 has an annular shape and N poles and S poles are alternately disposed in the circumferential direction. The sensor magnet 73 is fitted to the outer peripheral surface of the sensor magnet holding member.

Accordingly, the sensor magnet 73 is held by the sensor magnet holding member, and is disposed so that it is rotatable together with the shaft 41 around the axis (+θ direction) of the shaft 41 on the rear side (−Z side) of the bearing 42.

The rotation sensor is attached to a front surface of the circuit board on the front side (+Z side) of the circuit board. The rotation sensor is provided at a position that faces the sensor magnet 73 in the axial direction (Z axis direction). The rotation sensor detects change in the magnetic flux of the sensor magnet 73. The rotation sensor is, for example, a Hall IC or an MR sensor. Specifically, when Hall ICs are used, three are provided.

### <Cover>

The cover 13 is attached to the rear side (−Z side) of the housing 12. The material of the cover 13 is, for example, a metal. The cover 13 includes a tubular part 22a, a lid part 22b, and a flange part (cover side) 24. The tubular part 22a opens to the front side (+Z side).

The tubular part 22a surrounds the bus bar assembly 60, and more specifically, the rear side (−Z side) end of the bus bar holder 61, from the outer side in the radial direction of the central axis J. The tubular part 22a is connected to the rear side end of the bus bar assembly insertion part 21a in the housing 12 with the flange part (housing side) 15 and the flange part (cover side) 24 therebetween.

The lid part 22b is connected to the rear side end of the tubular part 22a. In the present example embodiment, the lid part 22b has a flat plate shape. The lid part 22b blocks a rear side opening of the bus bar holder 61. A front side surface of the lid part 22b is in contact with the entire circumference of the rear side O-ring 82. Accordingly, the cover 13 is indirectly in contact with the rear surface of the main body part on the rear side of the bus bar holder 61 via the rear side O-ring 82 over one circumference around an opening of the bus bar holder 61.

The flange part (cover side) 24 extends radially outward from the front side end of the tubular part 22a. In the housing 12 and the cover 13, the flange part (housing side) 15 and the flange part (cover side) 24 are bonded in an overlapping manner.

An external power supply is connected to the motor unit 20 via a connector part 63. The connected external power supply is electrically connected to a bus bar 91 and a wiring member 92 that protrude from a bottom surface of a power supply opening 63a of the connector part 63. Accordingly, a drive current is supplied to the coil 53 of the stator 50 and the rotation sensor through the bus bar 91 and the wiring member 92. The drive current supplied to the coil 53 is controlled according to, for example, a rotation position of the rotor 40 measured by the rotation sensor. When a drive current is supplied to the coil 53, a magnetic field is generated and the rotor 40 rotates according to this magnetic field. In this manner, the motor unit 20 obtains a rotational driving force.

### <Pump Unit>

The pump unit 30 is positioned on one side of the motor unit 20 in the axial direction, and specifically, on the front side (+Z axis side). The pump unit 30 is driven by the motor unit 20 via the shaft 41. The pump unit 30 includes the pump body 31, a pump rotor 35, and a pump cover 32. Hereinafter, the pump cover 32 and the pump body 31 are referred to as a pump case.

The pump body 31 is fixed into the housing 12 on the front side of the motor unit 20. An O-ring 71 is attached to the pump body 31. The O-ring 71 is provided between the outer peripheral surface of the pump body 31 and the inner peripheral surface of the housing 12 in the radial direction. Therefore, a gap between the outer peripheral surface of the pump body 31 and the inner peripheral surface of the housing 12 in the radial direction is sealed. The pump body 31 has a pump chamber 33 in which the pump rotor 35 recessed from the surface of the front side (+Z side) to the rear side (−Z side) is accommodated. The shape of the pump chamber 33 when viewed in the axial direction is a circular shape.

The pump body 31 has a through-hole 31a which is open at both ends in the axial direction, through which the shaft 41 passes, and of which the front side opening opens to the pump chamber 33. The rear side opening of the through-hole 31a opens toward the motor unit 20. The through-hole 31a functions as a bearing member that rotatably supports the shaft 41.

The pump body 31 has an exposed part 36 that is positioned on the front side relative to the housing 12 and is exposed to the outside of the housing 12. The exposed part 36 is a part of the front side end of the pump body 31. The exposed part 36 has a columnar shape that extends in the axial direction. The exposed part 36 overlaps the pump chamber 33 in the radial direction.

The pump rotor 35 is attached to the shaft 41. More specifically, the pump rotor 35 is attached to the front side end of the shaft 41. The pump rotor 35 includes an inner rotor 37 attached to the shaft 41 and an outer rotor 38 surrounding the outer side of the inner rotor 37 in the radial direction. The inner rotor 37 has an annular shape. The inner rotor 37 is a gear having teeth on the outer surface in the radial direction.

The inner rotor 37 is fixed to the shaft 41. More specifically, the front side end of the shaft 41 is press-fitted into the inner rotor 37. The inner rotor 37 rotates around the axis (θ direction) together with the shaft 41. The outer rotor 38 has an annular shape surrounding the outer side of the inner rotor 37 in the radial direction. The outer rotor 38 is a gear having teeth on the inner surface in the radial direction.

The inner rotor 37 and the outer rotor 38 are engaged with each other, and when the inner rotor 37 rotates, the outer rotor 38 rotates. That is, the pump rotor 35 rotates according to rotation of the shaft 41. In other words, the motor unit 20 and the pump unit 30 have the same rotation axis. Therefore, it is possible to prevent the size of the electric oil pump from increasing in the axial direction. When the inner rotor 37 and the outer rotor 38 rotate, a volume between engaged parts of the inner rotor 37 and the outer rotor 38 changes. An area in which the volume decreases is defined as a pressurized area and an area in which the volume increases is defined as a negative pressure area. A suction port 32c is disposed on one side of the negative pressure area of the pump rotor 35 in the axial direction. In addition, a discharge port 32d is disposed on one side of the pressurized area of the pump rotor 35 in the axial direction. Here, oil sucked from the suction port 32c into the pump chamber 33 is accommodated in a volume part between the inner rotor 37 and the outer rotor 38 and can be sent toward the discharge port 32d. Then, the oil is discharged from the discharge port 32d.

The pump cover 32 is attached to the front side of the pump body 31. The pump cover 32 includes a pump cover main body 32a and a pump discharge cylindrical part 32b. The pump cover main body 32a has a disc shape that extends in the radial direction. The pump cover main body 32a blocks the front side opening of the pump chamber 33. The pump discharge cylindrical part 32b has a cylindrical shape that extends in the axial direction. The pump discharge cylindrical part 32b is open at both ends in the axial direction. The pump discharge cylindrical part 32b extends from the pump cover main body 32a to the front side.

The pump unit 30 has the discharge port 32d and the suction port 32c. The discharge port 32d and the suction port 32c are provided on the pump cover 32. The discharge port 32d includes the inside of the pump discharge cylindrical part 32b. The discharge port 32d and the suction port 32c open on the front side surface of the pump cover 32. The discharge port 32d and the suction port 32c are connected to the pump chamber 33, and it is possible to suck oil into the pump chamber 33 and discharge oil from the pump chamber 33.

When the shaft 41 rotates in one circumferential direction (−θ direction), oil is sucked into the pump chamber 33 from the suction port 32c. The oil sucked into the pump chamber 33 is sent by the pump rotor 35 and is discharged to the discharge port 32d. In addition, in the pump device 10 of the present example embodiment, oil sucked into the pump chamber 33 is sent by the pump rotor 35, and flows into the motor unit 20 through the shaft 41. Specifically, most of the oil is discharged from the pressurized area to the discharge port 32d, but a part thereof passes through the gap between the inner rotor 37 and the pump body 31 in the axial direction and flows to the vicinity of the shaft 41. Then, the oil passes between the shaft 41 and the pump body 31, and flows into the motor unit 20. Accordingly, it is possible to cool the motor unit 20.

Next, a cooling structure of the pump device 10 according to the present example embodiment will be described. In the present example embodiment, oil supplied from an external device flows from the suction port 32c to the discharge port 32d due to the pump rotor 35, is sucked into the motor unit 20, and circulates in the motor unit 20, and thus cooling of the stator 50 and the rotor 40 is realized.

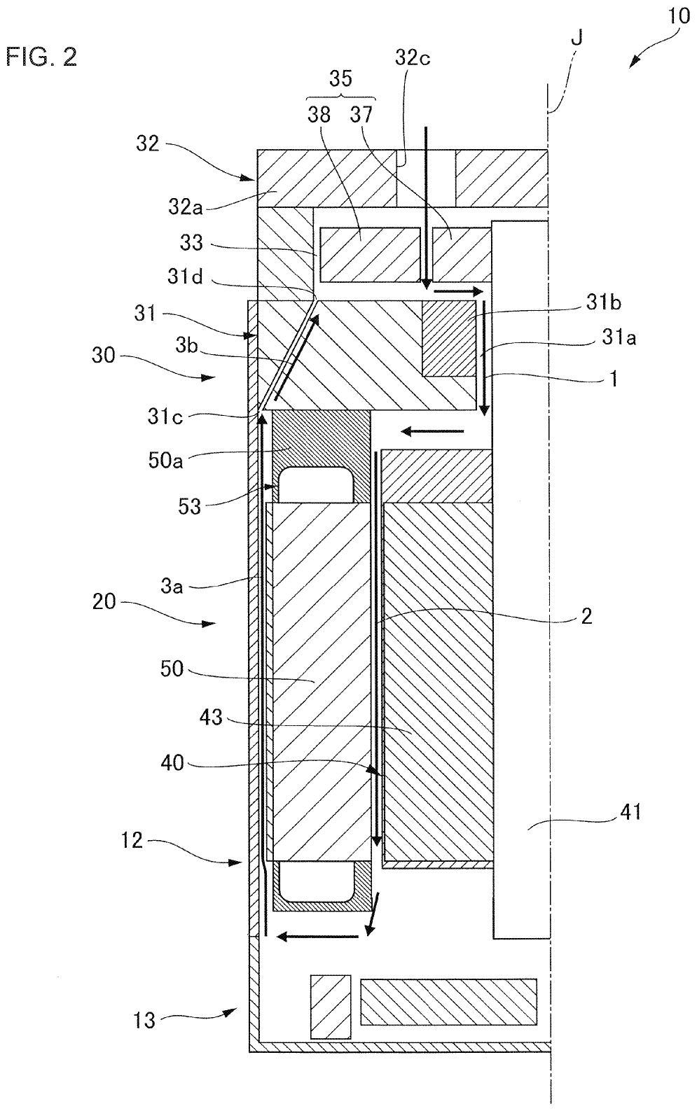

FIG. 2 is a diagram schematically showing main parts of the pump device 10 in order to allow easy understanding of oil flow paths in the pump device 10 shown in FIG. 1.

As shown in FIG. 2, the pump device 10 includes a first flow path 1 that connects the inside of the pump unit 30 and the inside of the housing 12, a second flow path 2 that is provided between the stator 50 and the rotor 40, and third flow paths 3a and 3b that are connected to the suction port (pump suction port) 32c of the pump unit 30 through the outside of the stator 50 and the rotor 40 in the radial direction from the second flow path 2. Hereinafter, the flow paths will be described in detail.

### <First Flow Path>

The first flow path 1 in FIG. 2 is provided between the pump body 31 of the pump unit 30 and the shaft 41. When the pump device 10 operates, most of oil sucked from the suction port 32c is discharged from a pressurized area of the pump rotor 35 to the discharge port 32d (refer to FIG. 1), but a part thereof passes through the gap between the inner rotor 37 and the pump body 31 in the axial direction and flows to the vicinity of the shaft 41. Then, the oil passes between the shaft 41 and the pump body 31, that is, flows into the motor unit 20 through the first flow path 1. Here, for convenience of description, FIG. 2 shows a state in which oil sucked from the suction port 32c is directly led to the first flow path 1. That is, as indicated by arrows showing flow paths in FIG. 2, oil sucked from the suction port 32c passes through the gap between the inner rotor 37 and the pump body 31 in the axial direction from the pressurized area of the pump rotor 35, and a path that flows through the first flow path 1 is omitted.

In the present example embodiment, the pump body 31 has a sliding bearing structure, that is, a bearing member 31b. The first flow path 1 is positioned between the outer peripheral surface of the shaft 41 and the inner peripheral surface of the pump body 31. In this case, oil flowing from the pump unit 30 in the first flow path 1 can be used as a lubricating oil, and the oil can be efficiently sucked into the motor unit 20. Here, in the first flow path 1, a cutout part may be provided in at least one of the outer peripheral surface of the shaft 41 and the inner peripheral surface of the pump body 31. Therefore, a flow path resistance of the first flow path 1 decreases and oil can be sucked from the pump unit 30 to the motor unit 20 more efficiently.

Here, the bearing member 31b is not limited to a sliding bearing. For example, any ball bearing may be used as the bearing member 31b. In this case, the first flow path 1 is positioned between the bearing member 31b (bearing) and the pump body 31. Like the case of the sliding bearing, in the first flow path 1, a cutout part or a through-hole may be provided in at least one of the bearing member 31b (bearing) and the pump body 31. Therefore, a flow path resistance of the first flow path 1 decreases and oil can be sucked into the motor unit 20 from the pump unit 30 more efficiently. When the bearing member 31b is ball bearing having a plurality of balls, the first flow path 1 may be disposed between adjacent balls.

### <Second Flow Path>

The second flow path 2 in FIG. 2 is provided between the stator 50 and the rotor 40. In the example shown in FIG. 2, the second flow path 2 is positioned between the inner peripheral surface of the stator 50 and the outer peripheral surface of the rotor 40. Oil flowing into the first flow path 1 flows from the front side one end to the rear side one end of the second flow path 2.

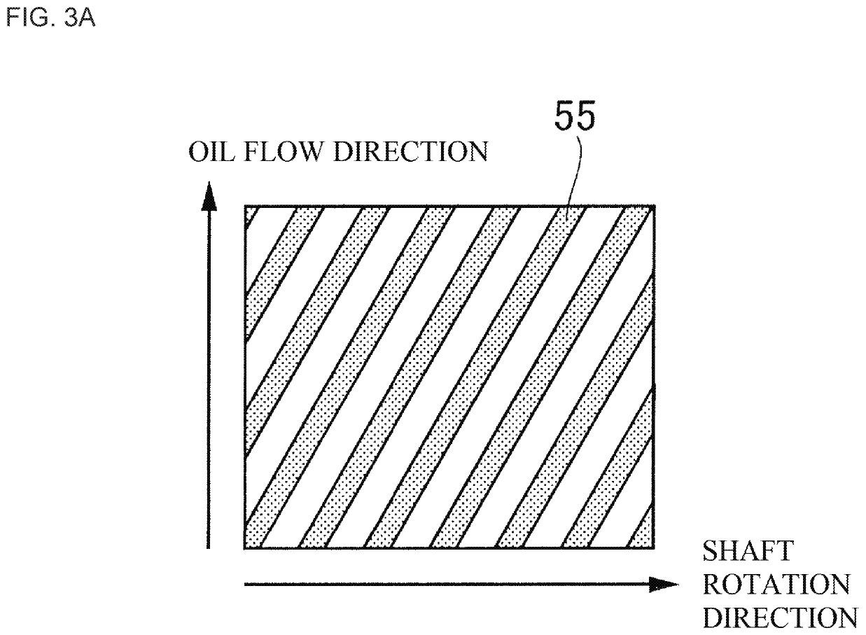

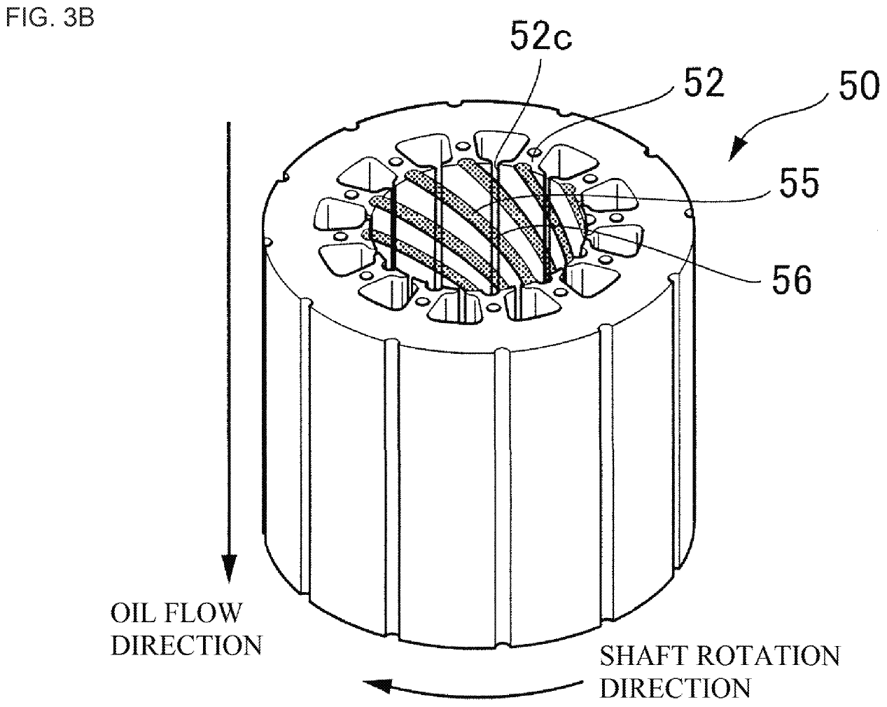

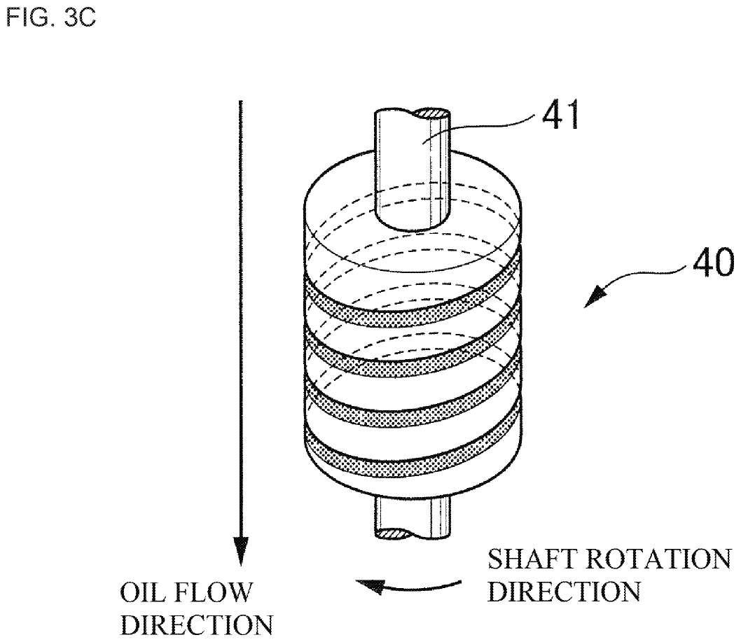

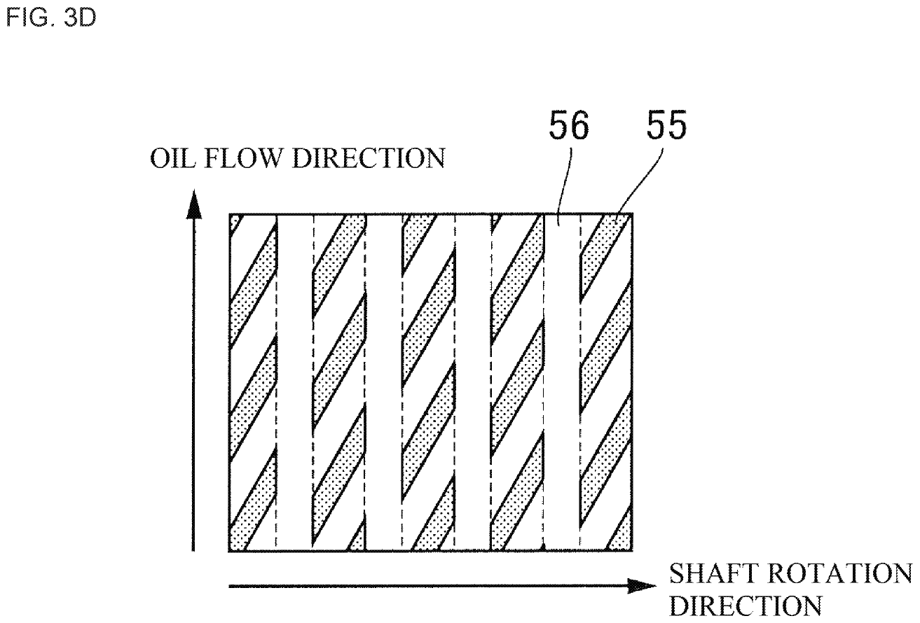

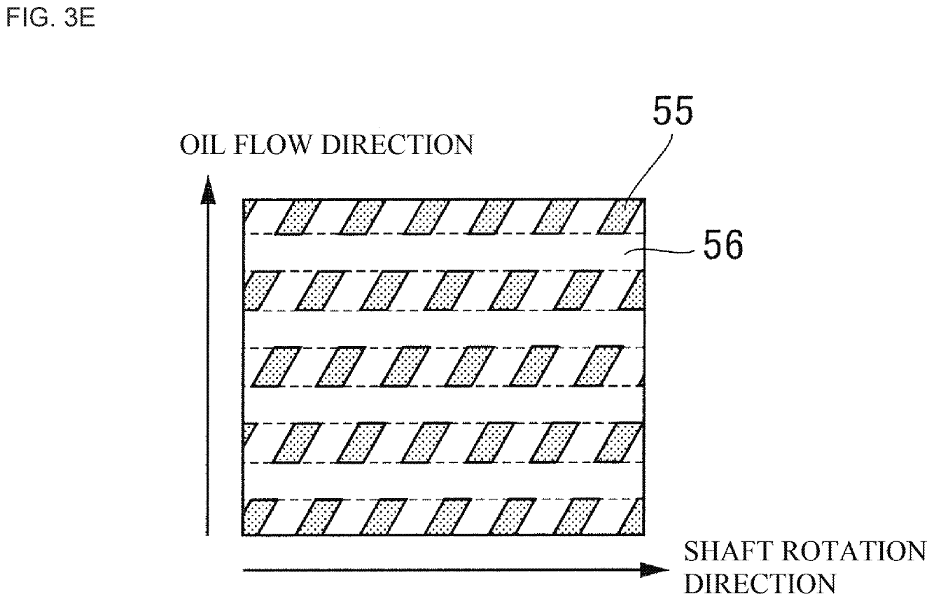

Here, in the present example embodiment, one or a plurality of grooves 55 are provided on the inner peripheral surface of the stator 50 or the outer peripheral surface of the rotor 40. FIG. 3A is a diagram showing an inclination of the groove 55 with respect to an oil flow direction and a rotation direction in the present example embodiment. As shown in FIG. 3A, on the inner peripheral surface of the stator 50 or the outer peripheral surface of the rotor 40, the groove 55 is inclined with respect to the oil flow direction. In the present example embodiment, in the second flow path 2, the oil flow direction is directed from the front side to the rear side. The groove may be a linear groove or a spiral groove.

FIG. 3B is a diagram showing an example when a groove is provided on the inner peripheral surface of the stator 50. FIG. 3C is a diagram showing an example when a groove is provided on the outer peripheral surface of the rotor 40. In both FIG. 3B and FIG. 3C, when respective circumferential surfaces widen, the inclination of the groove 55 with respect to the oil flow direction and the rotation direction of the shaft becomes the inclination shown in FIG. 3A.

According to the present example embodiment, in order to cause oil to flow into the motor using pressurization from the pump rotor 35 and circulate oil into the motor unit 20, a groove is provided in the second flow path 2 and thus the oil can circulate efficiently. When oil circulates in the motor unit 20 efficiently, it is possible to reduce generation of heat in the rotor magnet 44 and it is possible to reduce demagnetization. In addition, when oil circulates in the motor unit 20 efficiently, it is possible to provide a structure that cools the rotor 40 and the stator 50 at the same time. That is, it is possible to provide a structure having an excellent cooling effect for preventing the temperature of the motor unit 20 from increasing.

As shown in FIG. 3D or FIG. 3E, the groove 55 may have an intermittent part 56 that protrudes in the radial direction (outside in the radial direction or inside in the radial direction). The intermittent part 56 is a part in which the groove is interrupted halfway. The intermittent part 56 that protrudes in the radial direction includes a part in which the groove 55 is not provided on the circumferential surface in which the groove 55 is provided in the rotor 40 or the stator 50. FIG. 3D is a diagram showing a case in which the intermittent part 56 extends in the axial direction. FIG. 3E is a diagram showing a case in which the intermittent part 56 extends in the circumferential direction. As shown in FIG. 3B, when the groove 55 is provided on the inner peripheral surface of the stator 50, a gap 52c of the adjacent tooth part 52 corresponds to the intermittent part that protrudes from the groove to the outside in the radial direction.

The shape of the groove is not particularly limited, and, for example, a spiral groove may be used. Compared to a groove with another shape, a spiral groove can further improve a flow of oil in the second flow path 2 and circulate oil in the motor unit 20 more efficiently. In addition, for example, an annular groove around one circumference of the outer peripheral surface of the rotor 40 or the inner peripheral surface of the stator may be provided. FIG. 3C is a diagram showing an example in which a plurality of annular grooves 55 around one circumference of the outer peripheral surface of the rotor 40 are provided in the axial direction. The groove 55 may be a linear groove. An annular groove and a linear groove can be processed more easily than a spiral groove.

Here, the pitch of grooves, the shape and cross-sectional shape of grooves, the depth of grooves, the width of grooves, and other sizes of grooves are not particularly limited, and may be determined according to the shaft diameter of the stator 50 or the rotor 40 in which a groove is provided, an amount of oil supplied and a load, ease of processing, and the like. The pitch of grooves, sizes of grooves, and the like need not be constant, and, for example, the depth of grooves may become shallower in the oil flow direction.

Here, the second flow path 2 is not limited to being between the inner peripheral surface of the stator 50 and the outer peripheral surface of the rotor 40. For example, a through-hole may be provided in the core back part 51 of the stator 50 (refer to FIG. 1) or the rotor core 43, and the through-hole may be used as the second flow path 2. That is, the second flow path 2 may be provided at an arbitrary position between the stator 50 and the rotor 40. Accordingly, it is possible to cool the coil 53 of the stator 50 more efficiently and it is possible to cool the rotor.

As shown in FIG. 2, one end on the side of the motor unit 20 of the first flow path 1 is provided in the vicinity of the side of the motor unit 20 of the through-hole 31a as an opening through which the shaft 41 passes in the pump body 31. Therefore, when the second flow path 2 is provided at a position (near) connected to one end on the side of the motor unit 20 of the first flow path 1, most of oil is discharged from the discharge port 32d (refer to FIG. 1). That is, since a distance from the discharge port 32d to the first flow path 1 is long, an amount of oil flowing toward the first flow path 1 is smaller than an amount of oil discharged from the discharge port 32d. Thereby, since a discharge pressure of the pump is not impaired, it is possible to prevent the performance of the pump from deteriorating.

### <Third Flow Path>

The third flow path is a flow path that is connected to the suction port (pump suction port) 32c of the pump unit 30 from the second flow path through the outside of the stator 50 and the rotor 40 in the radial direction, and includes the third flow path 3a and the third flow path 3b in the example shown in FIG. 2. The third flow path 3a is a flow path that is provided radially outward from the stator 50 and the rotor 40, and the third flow path 3b is provided in the pump body 31 and is a flow path connecting the flow path 3a and the inside of the pump unit 30.

In the example shown in FIG. 2, the third flow path 3a is positioned between the outer peripheral surface of the stator 50 and the inner peripheral surface of the housing 12. Here, the third flow paths 3a and 3b are not limited to the example shown in FIG. 2. For example, it may be a flow path connected to the suction port (pump suction port) 32c of the pump unit 30 through the outside of the pump device 10 as the outside of the stator 50 and the rotor 40 in the radial direction. In this case, the third flow path may include the outside of the pump device 10.

Hereinafter, the third flow path 3a will be described.

Oil flowing into the first flow path 1 flows from the rear side one end to the front side one end of the third flow path 3a through the second flow path 2. When the third flow path 3a is provided, since it is possible to increase a surface area of the stator 50 in contact with oil, it is possible to cool the stator 50 more efficiently. Generally, in the motor, the coil generates heat most intensively. Heat generated in the coil is transmitted to the stator core. That is, an amount of heat generated in the stator 50 in the motor unit 20 is large. Thereby, when it is described that it is possible to efficiently cool the stator 50, it means that it is possible to efficiently cool the motor unit 20.

As shown in FIG. 4, the third flow path 3a may have a cutout part 51a on the outer peripheral surface of the core back part 51. In addition, the third flow path 3a may have a cutout part 12a on the inner peripheral surface of the housing 12. The third flow path 3a may have both or either of the cutout part 51a and the cutout part 12a. Here, a part in which a cutout part is provided in the stator 50 is not limited to the outer peripheral surface, but it may be provided, for example, on the inner peripheral surface.

When the stator 50 has the cutout part 51a, since it is possible to increase a surface area of the stator 50 in contact with oil, it is possible to cool the inside of the motor unit 20 more efficiently. In addition, when the stator 50 has the cutout part 51a or the housing 12 has the cutout part 12a, since it is possible to increase a flow rate of oil flowing into the third flow path 3a, it is possible to circulate oil more efficiently.

Here, the third flow path 3a is not limited to a space between the outer peripheral surface of the stator 50 and the inner peripheral surface of the housing 12. For example, as shown in FIG. 4, a through-hole 52b is provided in the core back part 51 of the stator 50 and the through-hole 52b may be used as the third flow path 3a. Accordingly, it is possible to cool the coil 53 of the stator 50 more efficiently. In addition, a space between adjacent tooth parts 52 may be used as the third flow path 3a.

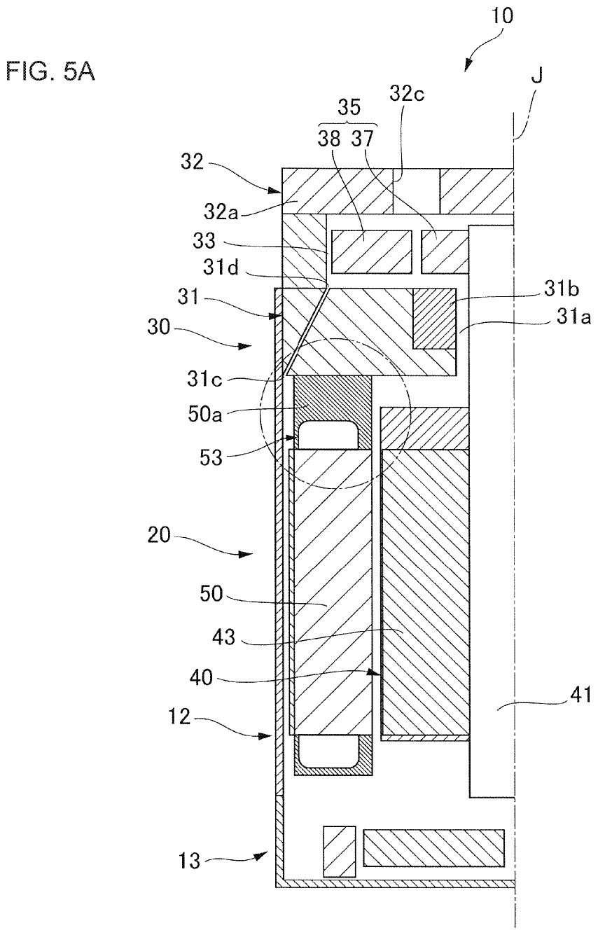

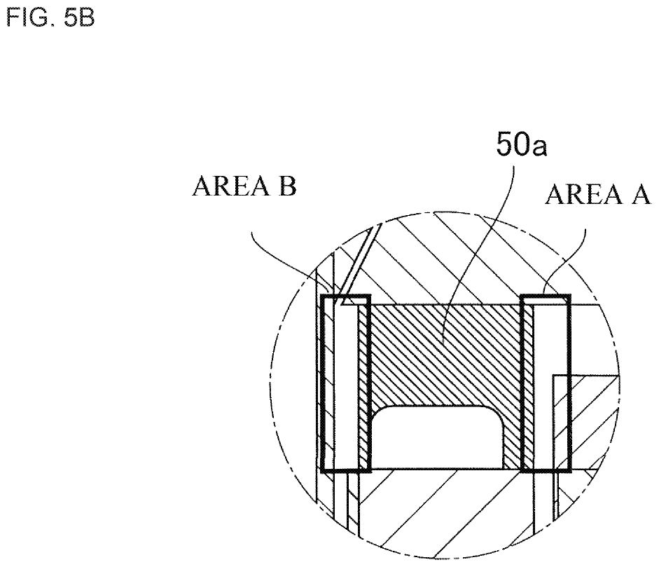

In the present example embodiment, the stator 50 and the pump body 31 are in contact with each other. As shown in FIG. 5, the stator 50 is molded with a resin. That is, the stator 50 is an integrally molded article made of a resin, and has a structure in which a front side one end 50a of the stator 50 and the pump body 31 are in contact with each other. Specifically, parts except for the inner peripheral surface of the tooth part 52 (refer to FIG. 3) and the outer end of the core back part 51 are molded with a resin. That is, the entire coil is covered with a resin. As shown in FIG. 5, when the stator 50 and the pump body 31 molded with a resin are in contact with each other so that they have an annular contact part in the circumferential direction, an area A into which oil flows from the first flow path 1 and an area B connected from the third flow path 3a to the third flow path 3b are separated. Therefore, oil flowing from the first flow path 1 into the area A does not flow into the area B. Thus, oil flowing into the motor unit 20 can flow through the first flow path 1, the second flow path 2, and the third flow path 3 in this order, and an unnecessary circulation path is not formed. That is, the circulating oil is unlikely to accumulate. Therefore, oil is efficiently and sequentially transferred in the flow paths.

Here, in the present example embodiment, since the stator 50 is an integrally molded article made of a resin, the front side one end in which the stator 50 is in contact with the pump body 31 is provided. However, the present disclosure is not limited thereto. For example, the stator 50 and the pump body 31 may be brought into contact with each other using a ring member fitted between the stator 50 and the pump body 31. As shown in FIG. 5, it is not necessary cover all coil ends of the stator 50 with a resin, and the front side one end 50a of the stator 50 may have any shape in which the area A and the area B are separated.

When the stator 50 is an integrally molded article made of a resin, it is possible to increase a surface area of the stator 50 in contact with oil in the second flow path 2 and the third flow path 3a. Therefore, it is possible to cool the inside of the motor unit 20 more efficiently. Here, when the stator 50 is an integrally molded article made of a resin and the groove 55 in the second flow path 2 is provided on the stator 50, the stator 50 has the groove 55 on the resin.

Like the stator 50, the rotor 40 may be molded with a resin. That is, the rotor 40 may be an integrally molded article made of a resin. When the rotor 40 is an integrally molded article made of a resin, it is possible to increase a surface area of the rotor 40 in contact with oil in the second flow path 2. Therefore, it is possible to further cool the rotor magnet 44, it is possible to prevent demagnetization of the rotor magnet 44, and it is possible to cool the motor unit 20 more efficiently. Here, when the rotor 40 is an integrally molded article made of a resin and the groove 55 in the second flow path 2 is provided on the stator 50, the rotor 40 has the groove 55 on the resin.

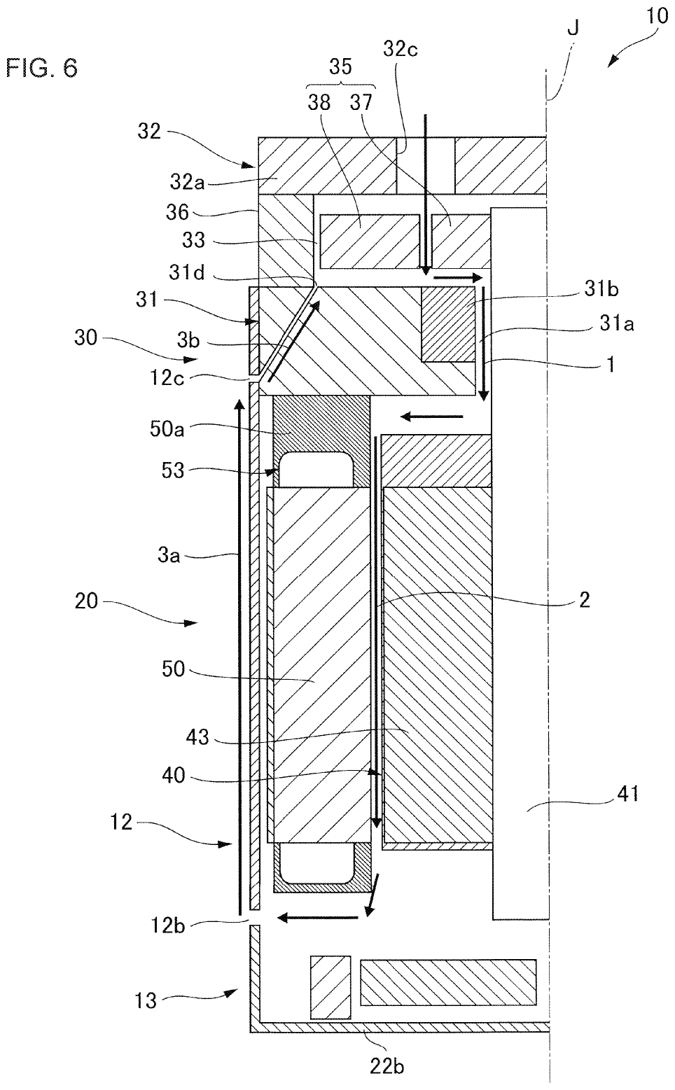

In addition, in the example shown in FIG. 2, the third flow path 3a and the third flow path 3b are disposed in the pump device 10, but the present disclosure is not limited thereto. The third flow path may be a flow path connected to the pump suction port through the outside of the stator 50 and the rotor 40 in the radial direction. For example, a part or all of the third flow path may be disposed outside the housing 12. A modified example of the third flow path will be described below with reference to FIG. 6.

Next, the third flow path 3b will be described.

The third flow path 3b in FIG. 2 is provided in the pump body 31 and connects the third flow path 3a and the inside of the pump unit 30. Specifically, the third flow path 3b has a first opening 31c in the vicinity of the front side one end of the third flow path 3a of the motor unit 20 and a second opening 31d in the vicinity of the suction port 32c of the pump chamber 33. The third flow path 3b connects the third flow path 3a of the motor unit 20 and the pump chamber 33. When the third flow path 3b is provided, oil sucked into the motor unit 20 through the first flow path 1 can circulate from the inside of the motor unit 20 to the inside of the pump unit 30. Oil flowing into the motor unit 20 from the first flow path 1 returns to the inside of the pump unit 30 from the third flow path 3b without passing through a wasteful circulation path as described above. Since the temperature of oil that passes through the first flow path 1 is lower than the temperature of oil that passes through the third flow path 3b, oil with a low temperature always circulates the inside of the motor unit 20. Accordingly, it is possible to efficiently cool the stator 50 and the rotor 40.

The first flow path 1 is positioned radially inward from the third flow path 3b. Therefore, it is possible to secure a distance between the first flow path 1 and the third flow path 3b in a direction orthogonal to the axial direction. When the distance between the first flow path 1 and the third flow path 3b is short, it is possible to prevent formation of a flow path through which oil with a high temperature returned to the inside of the pump unit 30 through the third flow path 3b returns to the first flow path 1. Thereby, it is possible to efficiently cool the inside of the motor unit 20.

A cross-sectional area of the first opening 31c which is a rear side opening of the third flow path 3b is smaller than a cross-sectional area of the discharge port 32d of the pump unit 30. Therefore, an amount of oil flowing from the inside of the motor unit 20 to the inside of the pump unit 30 becomes smaller than a discharge amount of the pump, and it is possible to prevent an amount of oil flowing into the motor unit 20 from becoming excessive. That is, it is possible to prevent deterioration of the pump efficiency due to an excess amount of oil flowing into the motor unit 20 and it is possible to cool the inside of the motor unit 20 more efficiently.

<Modified Example of Flow Path>

In the example shown in FIG. 2, the third flow path 3a and the third flow path 3b are provided inside the pump device 10, but the present disclosure is not limited thereto. For example, the third flow path may include a flow path provided outside the pump device 10. FIG. 6 is a diagram for explaining a case in which a part of the third flow path passes through the outside of the pump device 10 as an example. In the example shown in FIG. 6, the third flow path includes the third flow path 3a provided outside the housing 12 and the third flow path 3b connecting the third flow path 3a and the inside of the pump unit 30. The housing 12 has a first through-hole 12b and a second through-hole 12c.

In the example shown in FIG. 6, the third flow path 3a is provided in an external device (not shown) to which the pump device 10 and the pump device 10 are attached. The third flow path 3a may be provided in any manner as long as it is a flow path connecting the first through-hole 12b and the second through-hole 12c. That is, the third flow path 3a may include an arbitrary flow path connecting the first through-hole 12b and the second through-hole 12c.

The positions of the first through-hole 12b and the second through-hole 12c are not limited to the positions shown in FIG. 6, but they may be provided at arbitrary positions such as the side surface of the housing 12 and the lid part 22b of the cover 13. Oil from the second flow path 2 is discharged to the outside of the housing 12 through the first through-hole 12b, flows into the third flow path 3a, and thus flows from the rear side to the front side of the pump device 10, and flows into the third flow path 3b through the second through-hole 12c.

Here, in the example shown in FIG. 6, the third flow path 3b is provided in the pump body 31, and is a flow path connecting the second through-hole 12c and the second opening 31d, but the present disclosure is not limited thereto. For example, a through-hole connecting the outside of the pump device 10 and the suction port (pump suction port) 32c of the pump unit 30 is provided in the exposed part 36 of the pump body 31, and the through-hole may serve as the flow path 3b. In this case, since it is not necessary to provide a through-hole in both the housing 12 and the pump body 31, and a through-hole may be provided only in the exposed part 36 of the pump body 31, processing is easy. In addition, in the example shown in FIG. 6, the third flow path 3b is provided in the pump body 31, but the present disclosure is not limited thereto, and the third flow path 3b may be provided in, for example, the pump cover 32.

For example, the pump device 10 may additionally have a flow path provided between the outer peripheral surface of the shaft 41 and the inner peripheral surface of the rotor 40 as another flow path. In addition, for example, a through-hole (not shown) is provided in the rotor 40, and the through-hole may be used as a flow path. In this manner, when another flow path is provided in addition to the first flow path 1 to the third flow path 3b, it is possible to circulate oil between the pump unit 30 and the motor unit 20 more efficiently and it is possible to cool the motor unit 20 with high efficiency.

According to the present example embodiment, the pump device 10 includes the shaft 41 that rotates around the central axis that extends in the axial direction, the motor unit 20 that rotates the shaft 41, and the pump unit 30 that is positioned on one side of the motor unit 20 in the axial direction, is driven by the motor unit 20 via the shaft 41, and discharges oil. The motor unit 20 includes the rotor 40 that rotates around the shaft 41, the stator 50 that is disposed to face the rotor 40, and the housing 12 in which the rotor 40 and the stator 50 are accommodated. The pump unit 30 includes the pump rotor 35 attached to the shaft 41 and pump cases 31 and 32 in which the suction port 32c into which oil is sucked and the discharge port 32d from which oil is discharged are provided and the pump rotor 35 is accommodated. The pump device 10 includes the first oil flow path 1 connecting the inside of the pump unit 30 and the inside of the housing 12, the second oil flow path 2 provided between the stator 50 and the rotor 40, and the third oil flow paths 3a and 3b connected to the suction port 32c of the pump unit 30 through the outside of the stator 50 and the rotor 40 in the radial direction from the second flow path 2. One or a plurality of grooves 55 are provided on the outer peripheral surface of the rotor 40 or the inner peripheral surface of the stator 50, and the groove 55 is inclined with respect to the oil flow direction.

The pump device 10 allows oil to flow into the motor unit 20 using pressurization by the pump rotor 35. Here, the groove 55 inclined with respect to the oil flow direction is provided between the stator 50 and the rotor 40 in which the second flow path 2 is provided, that is, on the outer peripheral surface of the rotor 40 or the inner peripheral surface of the stator 50. Accordingly, it is possible to efficiently circulate oil in the motor unit 20. When oil efficiently circulates in the motor unit 20, it is possible to prevent generation of heat in the rotor magnet 44 and it is possible to prevent demagnetization. In addition, it is possible to provide a structure in which the rotor 40 and the stator 50 are cooled at the same time. That is, it is possible to provide the pump device 10 having a structure having an excellent cooling effect for preventing the temperature of the motor unit 20 from increasing.

### Second Example Embodiment

Next, a pump device according to a second example embodiment of the present disclosure will be described. In the first example embodiment, the motor unit has an inner rotor type motor configuration in which the stator is positioned radially outward from the rotor. On the other hand, a motor unit in the present example embodiment has an axial gap type motor configuration including two rotors attached to the shaft 41 with a predetermined interval in the axial direction and a stator disposed between the two rotors. Hereinafter, parts different from those in the first example embodiment will be mainly described. In the pump device according to the present example embodiment, components the same as those of the pump device according to the first example embodiment will be denoted with the same reference numerals and descriptions thereof will be omitted.

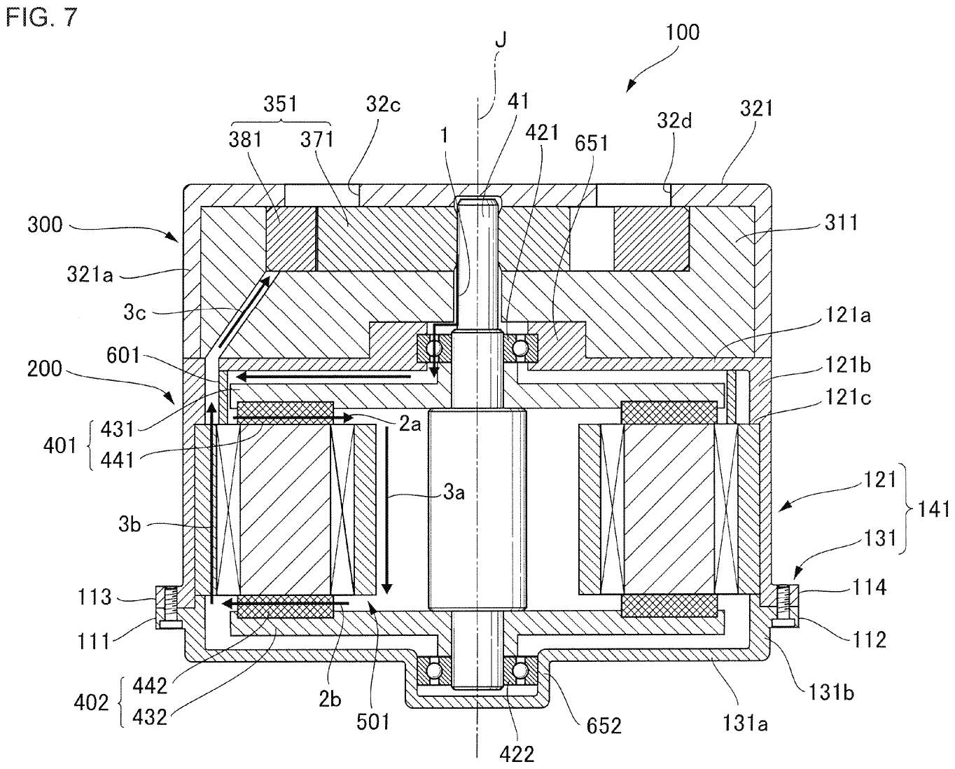

FIG. 7 is a cross-sectional view showing a pump device 100 of the present example embodiment.

As shown in FIG. 7, the pump device 100 includes the shaft 41, a motor unit 200, a housing 141, and a pump unit 300. The shaft 41 rotates around the central axis J that extends in the axial direction. The motor unit 200 and the pump unit 300 are provided in the axial direction side by side.

The motor unit 200 includes an upper rotor 401, a lower rotor 402, a stator 501, an upper bearing member 421, a lower bearing member 422, a bus bar assembly (not shown), and a connector (not shown). Both the lower rotor 402 and the upper rotor 401 have a disk shape that extends in the radial direction. The upper rotor 401 includes a plurality of upper magnets 441 that are arranged in the circumferential direction on the surface (−Z side surface) that faces the stator 501 and an upper rotor yoke 431 that holds the upper magnet 441.

The lower rotor 402 includes a lower magnet 442 and a lower rotor yoke 432. The lower rotor 402 includes a plurality of lower magnet 442 that are arranged in the circumferential direction on the surface (−Z side surface) that faces the stator 501 and the lower rotor yoke 432 that holds the lower magnet 442. That is, the upper magnet 441 and the lower magnet 442 are disposed to face each other on both surfaces of the stator 501 in the axial direction. The upper rotor yoke 431 and the lower rotor yoke 432 are coaxially fixed to the outer peripheral surface of the shaft 41.

The upper bearing member 421 and the lower bearing member 422 rotatably support the shaft 41. The upper bearing member 421 is fixed to the housing 141. The stator 501 includes a plurality of (12 in the second example embodiment) fan-shaped cores in a plan view arranged in the circumferential direction, coils provided in the cores, coil lead wires drawn out from the coils of the cores, a molding resin for integrally fixing the plurality of cores, and a plurality of lead wire supports provided at the outer peripheral end of the stator 501.

The housing 141 constitutes a casing of the motor unit 200. The stator 501 is held substantially at the center of the housing 141 in the axial direction. The lower rotor 402 is accommodated on the rear side (−Z side) of the stator 501. Here, a bus bar assembly (not shown) may be accommodated. The upper rotor 401 is accommodated on the front side (+Z side) of the stator 501. The housing 141 has a first housing 121 having a lidded cylindrical shape of which the rear side is open and a second housing (cover) 131 having a bottomed cylindrical shape connected to the rear side (−Z side) of the first housing 121. The material of the housing 141 is, for example, a metal or a resin.

A step part 121c is formed on the inner peripheral surface of a cylindrical part 121b of the first housing 121. The stator 501 is held by the step part 121c. The first housing 121 includes a disk-shape top wall 121a and an upper bearing holding part 651 provided at the center of the top wall 121a. The upper bearing holding part 651 is fitted to the rear side opening of the pump unit 300. The upper bearing holding part 651 holds the upper bearing member 421.

The second housing 131 includes a disk-shaped bottom wall 131a, a cover cylindrical part 131b that extends from the peripheral part of the bottom wall 131a to the front side (+Z side), and the lower bearing holding part 652 provided at the center of the bottom wall 131a. The cover cylindrical part 131b is fixed to the rear side (−Z side) opening of the first housing 121. More specifically, the first housing 121 and the second housing 131 are fixed by a method such as bolt fastening using flange parts 111 and 112 of the second housing 131 and flange parts 113 and 114 of the first housing 121.

When a bus bar assembly (not shown) is accommodated in the second housing 131, a through-hole (not shown) penetrating in the axial direction is provided at the bottom wall 131a of the second housing 131 and a connector (not shown) is attached to the through-hole. An external connection terminal (not shown) that extends from the bus bar assembly to the rear side (−Z side) through the bottom wall 131a is disposed in the connector.

The pump unit 300 is positioned on one side of the motor unit 200 in the axial direction, and specifically, on the front side (+Z axis side). The pump unit 300 is driven by the motor unit 200 via the shaft 41. The pump unit 300 includes a pump body 311, a pump rotor 351, and a pump cover 321. The pump rotor 351 includes an inner rotor 371 and an outer rotor 381. The pump cover 321 includes the suction port 32c and the discharge port 32d. Since respective members of the pump unit 300 are the same as those of the first example embodiment, descriptions thereof will be omitted.

Next, a cooling structure of the pump device 100 according to the present example embodiment will be described. As in the first example embodiment, oil supplied from an external device flows from the suction port 32c to the discharge port 32d due to the pump rotor 351, and is sucked into the motor unit 200, and circulates in the motor unit 200, and thus the stator 501, the upper rotor 401 and the lower rotor 402 are cooled. Hereinafter, regarding oil flow paths in the pump device 100, description will focus on parts different from those in the first example embodiment.

As shown in FIG. 7, the pump device 100 includes the first flow path 1 connecting the inside of the pump unit 300 and the inside of the housing 141, second flow paths 2a and 2b provided between the stator 501, and the upper rotor 401 and the lower rotor 402, and the third flow paths 3a to 3c connected to the pump suction port through the inside of the stator 501, the upper rotor 401 and the lower rotor 402 in the radial direction or the outside thereof in the radial direction from the second flow path 2a or 2b.

Since the first flow path 1 of the present example embodiment is the same as that in the first example embodiment, description thereof will be omitted. In the present example embodiment, the second flow path includes the following two low paths as shown in FIG. 7. The second flow path 2a, which is the first flow path, is positioned between the upper rotor 401 and one end of the stator 501 in the axial direction that faces the upper magnet 441 of the upper rotor 401. The second flow path 2b, which is the second flow path, is positioned between the lower rotor 402 and one end of the stator 501 in the axial direction that faces the lower magnet 442 of the lower rotor 402. Thereby, it is possible to cool the stator 501, the upper rotor 401 and the lower rotor 402 at the same time.

Here, in the present example embodiment, one or a plurality of grooves are provided on a facing surface in which the stator 501 faces the upper rotor 401 or the lower rotor 402. The groove is inclined with respect to the oil flow direction. The groove may be a linear groove or a spiral groove. According to the present example embodiment, in order to cause oil to flow the motor using pressurization from the pump rotor 351 and circulate oil into the motor unit 200, a groove is provided in the second flow path 2a or 2b, and thus the oil can circulate efficiently.

When oil circulates in the motor unit 200 efficiently, it is possible to reduce generation of heat in the upper rotor magnet 441 or the lower rotor magnet 442 and it is possible to reduce demagnetization. In addition, when oil circulates in the motor unit 200 efficiently, it is possible to provide a structure in which the upper rotor 401, the lower rotor 402, and the stator 501 are cooled at the same time. That is, it is possible to provide a structure having an excellent cooling effect for preventing the temperature of the motor unit 200 from increasing.

Here, the pitch of grooves, the shape and cross-sectional shape of grooves, the depth of grooves, the width of grooves, and other sizes of grooves are not particularly limited, and may be determined according to the shaft diameter of the stator 501, the upper rotor 401, or the lower rotor 402 in which a groove is provided, an amount of oil supplied and a load, ease of processing, and the like. The pitch of grooves, sizes of grooves, and the like need not be constant, and, for example, the depth of grooves may be shallow in the oil flow direction.

In the present example embodiment, the third flow path includes the following three flow paths as shown in FIG. 7. The third flow path 3a, which is the first flow path, is positioned between the stator 501 and the shaft 41, that is, inside of the stator 501, the upper rotor 401, and the lower rotor 402 in the radial direction. The third flow path 3b, which is the second flow path, is positioned between the stator 501 and the housing 141 that holds the stator 501.

That is, the third flow path 3b is positioned radially outward from the stator 501, the upper rotor 401, and the lower rotor 402. The third flow path 3c, which is the third flow path, is provided in the pump body 311 and is a flow path connecting the third flow path 3b and the inside of the pump unit 300. Here, the flow path 3c is provided in the pump body 311 in the example shown in FIG. 7, but the present disclosure is not limited thereto. As in the first example embodiment, the third flow path 3c may include an arbitrary flow path as long as it is a flow path connecting the flow path 3b and the suction port of the pump unit 300. As in the first example embodiment, in the present example embodiment, the pump device 100 has a structure having an excellent cooling effect in which the stator 501, the upper rotor 401, and the lower rotor 402 are cooled at the same time.

Here, as in the first example embodiment, the stator 501, the upper rotor 401, and the lower rotor 402 may be an integrally molded article made of a resin, and a groove is provided on the resin. In the case of the integrally molded article made of a resin, it is possible to increase a surface area of the stator 501, the upper rotor 401, or the lower rotor 402 in contact with oil. Therefore, it is possible to cool the inside of the motor unit 200 more efficiently.

According to the present example embodiment, the pump device 100 includes the shaft 41 that rotates around the central axis that extends in the axial direction, the motor unit 200 that rotates the shaft 41, and the pump unit 300 that is positioned on one side of the motor unit 200 in the axial direction, is driven by the motor unit 200 via the shaft 41, and discharges oil. The motor unit 200 includes the upper rotor 401 and the lower rotor 402 that rotate around the shaft 41, the stator 501 that is disposed to face the upper rotor 401 and the lower rotor 402 in the axial direction, and the housing 141 in which the upper rotor 401, the lower rotor 402, and the stator 501 are accommodated. The pump unit 300 includes the pump rotor 351 attached to the shaft 41 and pump cases 311 and 321 in which the suction port 32c into which oil is sucked and the discharge port 32d from which oil is discharged are provided and the pump rotor 351 is accommodated. The pump device 100 includes the first oil flow path 1 connecting the inside of the pump unit 300 and the inside of the housing 141, the second oil flow path 2 provided between the stator 501 and the upper rotor 401 or the lower rotor 402, and the third oil flow paths 3a to 3c connected to the pump suction port through the outside of the stator 501, the upper rotor 401, and the lower rotor 402 in the radial direction from the second flow path 2. One or a plurality of grooves 55 are provided on a facing surface in which the upper rotor 401 or the lower rotor 402 faces the stator 501, and the groove is inclined with respect to the oil flow direction.

The pump device 100 allows oil to flow into the motor unit 200 using pressurization by the pump rotor 351. Here, the groove 55 inclined with respect to the oil flow direction is provided between the stator 501 and the upper rotor 401 or the lower rotor 402 in which the second flow path is provided, that is, on a facing surface in which the upper rotor 401 or the lower rotor 402 faces the stator 501. Therefore, it is possible to circulate oil efficiently. When oil circulates in the motor unit 200 efficiently, it is possible to reduce generation of heat in the upper rotor magnet 441 and the lower rotor magnet 442 and it is possible to reduce demagnetization. In addition, it is possible to provide a structure in which the upper rotor 401, the lower rotor 402, and the stator 501 are cooled at the same time. That is, it is possible to provide a structure having an excellent cooling effect for preventing the temperature of the motor unit 200 from increasing.

Here, in the present example embodiment, a ring member 601 is provided between the front side one end of the stator 501 in the axial direction and the top wall 121a of the first housing 121. Accordingly, the ring member 601 is in contact with the stator 501 and the pump body 311 so that it has an annular contact part, and as in the first example embodiment, an area into which oil flows from the first flow path 1 and an area connected from the third flow path 3b to the third flow path 3c are separated. Thereby, oil flowing from the first flow path 1 does not flow through the third flow path 3c. Thus, in the motor unit 200, not only is it possible to circulate only oil from the first flow path 1 to the third flow path 3c, but it is also possible to provide a circulation path of oil in the stator 501, the upper rotor 401, and the lower rotor 402, and a structure having an excellent cooling effect inside the motor unit 200 is provided.

Here, as in the first example embodiment in FIG. 6, a through-hole is provided in the housing 141, and oil from the second flow path 2b may be discharged to the outside of the housing 141. In this case, the third flow path 3b is positioned outside the housing 141.

In addition, while a case in which the stator 501 is fixed to the cylindrical part 121b of the housing 141 has been described in the pump device 100 of the present example embodiment, the present disclosure is not limited thereto. Even if the stator 501 of the pump device 100 is fixed to the shaft 41, the present disclosure can be applied, and the pump device 100 has a cooling structure with similar flow paths.

In addition, while a case in which the motor unit 200 of the pump device 100 includes both the upper rotor 401 and the lower rotor 402 has been described in the present example embodiment, the present disclosure is not limited thereto. For example, the present disclosure can also be applied to the pump device 100 including only the lower rotor 402. In this case, the pump device 100 includes only the second flow path 2b as the second flow path.

### Third Example Embodiment

Next, a pump device according to a third example embodiment of the present disclosure will be described. In the first example embodiment, the motor unit 20 of the pump device 10 has an inner rotor type motor configuration. In the second example embodiment, the motor unit 200 of the pump device 100 has an axial gap type motor configuration. On the other hand, the motor unit 200 in the present example embodiment has an outer rotor type motor configuration in which a stator 5000 is positioned on the inner side of the rotor in the radial direction. Hereinafter, parts different from those in the first example embodiment and the second example embodiment will be mainly described. In the pump device according to the present example embodiment, components the same as those of the pump device according to the first example embodiment or the second example embodiment will be denoted with the same reference numerals and descriptions thereof will be omitted.

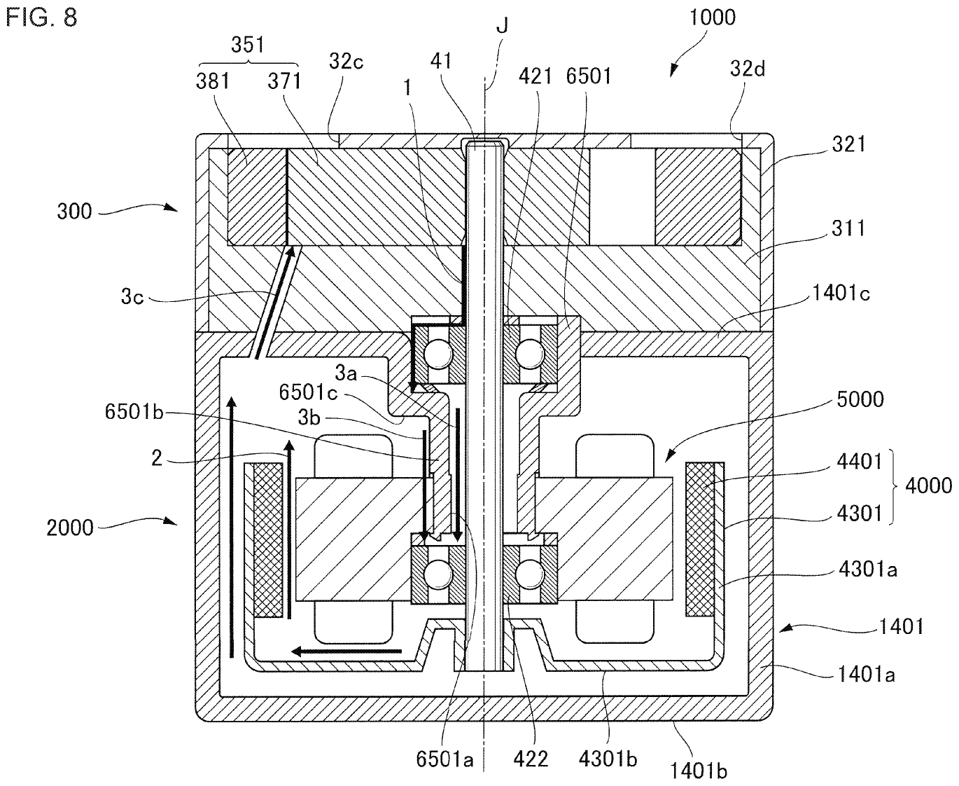

FIG. 8 is a cross-sectional view showing a pump device 1000 of the present example embodiment.

The pump device 1000 of the present example embodiment includes the shaft 41, a motor unit 2000, and the pump unit 300. The shaft 41 rotates around the central axis J that extends in the axial direction. The motor unit 2000 and the pump unit 300 are provided in the axial direction side by side.

As shown in FIG. 8, the motor unit 2000 includes a housing 1401, a rotor 4000, the stator 5000, a bearing housing 6501, the upper bearing member 421, the lower bearing member 422, a control device (not shown), and a bus bar assembly (not shown). Here, the control device and the bus bar assembly may not be built into the motor unit 2000, but it may be, for example, attached to the rear side one end of the housing 1401 in the axial direction or may be attached to a side surface 1401a of the housing 1401.

The rotor 4000 includes a rotor magnet 4401 and a rotor yoke 4301. The rotor yoke 4301 has a cup shape (front side opening) and includes a disc-shaped top plate part 4301b with the center to which the shaft 41 is connected and a cylindrical part 4301a provided so that the outer periphery of the top plate part 4301b extends toward the front side. The rotor magnet 4401 is disposed on the inner peripheral surface of the cylindrical part 4301a of the rotor yoke 4301, and the inner peripheral surface thereof faces the stator 5000 in the radial direction. The rotor 4000 is fixed to the shaft 41.

The bearing housing 6501 includes a bearing housing cylindrical part 6501b having a cylindrical shape, an annular protrusion 6501a provided on the inner peripheral surface of the bearing housing cylindrical part 6501b, and a flange part 6501c provided on the outer peripheral surface of the bearing housing cylindrical part 6501b. The annular protrusion 6501a protrudes inward so that the inner diameter of the bearing housing cylindrical part 6501b decreases.

On the inner peripheral surface of the bearing housing cylindrical part 6501b, the upper bearing member 421 is provided on the front side. On the inner peripheral surface of the bearing housing cylindrical part 6501b, the lower bearing member 422 is provided on the rear side. The upper bearing member 421 and the lower bearing member 422 are fitted to the shaft 41. The upper bearing member 421 and the lower bearing member 422 support the shaft 41 so that it is rotatable with respect to the bearing housing 6501.

The stator 5000 is fixed to the outer periphery of the bearing housing 6501. Specifically, the bearing housing 6501 is fitted into the inner peripheral surface of an annular core back of the stator 5000. A top wall 1401c of the housing 1401 connected to the rear side opening of the pump unit 300 is disposed on the front side of the stator 5000 and supports the bearing housing 6501. The control device (not shown) is disposed between a bottom wall 1401b of the housing 1401 and the stator 5000.

Next, a cooling structure of the pump device 1000 according to the present example embodiment will be described. As in the first example embodiment, oil supplied from an external device flows from the suction port 32c to the discharge port 32d due to the pump rotor 351, is sucked into the motor unit 2000, and circulates in the motor unit 2000. According to this circulation, the stator 5000 and the rotor 4000 are cooled. Hereinafter, regarding oil flow paths in the pump device 1000, description will focus on parts different from those in the first example embodiment and the second example embodiment.

As shown in FIG. 8, the pump device 1000 includes the first flow path 1 connecting the inside of the pump unit 300 and the inside of the housing 1401, the second flow path 2 provided between the stator 5000 and the rotor 4000, and third flow paths including the third flow paths 3a and 3b connected to the second flow path 2 through the inner side of the stator 5000 and the rotor 4000 in the radial direction from the first flow path and the flow path 3c connected to the pump suction port from the second flow path 2.

Since the first flow path 1 of the present example embodiment is the same as that in the first example embodiment, description thereof will be omitted. In the present example embodiment, the second flow path 2 is positioned between the outer peripheral surface of the stator 5000 and the inner peripheral surface of the rotor 4000 as shown in FIG. 8. In the present example embodiment, one or a plurality of grooves 55 are provided on the outer peripheral surface of the stator 5000 or the inner peripheral surface of the rotor 4000. As in the first example embodiment, as shown in FIG. 3A, on the outer peripheral surface of the stator 5000 or the inner peripheral surface of the rotor 4000, the groove 55 is inclined with respect to the oil flow direction.

In addition, as in the first example embodiment, the groove 55 may have the intermittent part 56 that protrudes in the radial direction (radially outward or radially inward) as shown in FIG. 3D or FIG. 3E. In addition, since the shape of the groove 55 and the like are the same as those in the first example embodiment, description thereof will be omitted.

In the present example embodiment, as shown in FIG. 8, the third flow path includes the following three flow paths. The third flow path 3a, which is the first flow path, is positioned between the bearing housing 6501 and the shaft 41. The third flow path 3b, which is the second flow path, is positioned between the stator 5000 and the bearing housing 6501. That is, the third flow path 3a and the third flow path 3b are both positioned on the inner side of the stator 5000 and the rotor 4000 in the radial direction and are flow paths connected to the second flow path 2 through the inner side of the stator 5000 and the rotor 4000 in the radial direction from the first flow path 1.

The third flow path 3c, which is the third flow path, is a flow path connected from the second flow path 2 to the pump suction port. Here, the third flow path 3c is provided in the pump body 311 in the example shown in FIG. 8, but the present disclosure is not limited thereto. The third flow path 3c may include an arbitrary flow path as long as it is a flow path connecting the second flow path 2 and the suction port of the pump unit 300. In the present example embodiment, as in the first example embodiment and the second example embodiment, the pump device 1000 has a structure having an excellent cooling effect in which the stator 5000 and the rotor 4000 are cooled at the same time.

In the present example embodiment, oil flowing into the first flow path 1 flows to the second flow path 2 through the third flow path 3a or 3b. Then, the second flow path 2 is connected to the third flow path 3c and the oil is returned to the pump unit 300. Here, the oil may flow from the second flow path 2 to the outer peripheral surface of the rotor yoke 4301 and the inner peripheral surface of the housing 1401. In this case, the oil accumulates on the bottom wall 1401b of the housing 1401 and eventually, the oil flows in a direction of the pump unit 300 between the outer peripheral surface of the rotor yoke 4301 and the inner peripheral surface of the housing 1401. Arrows indicating flow paths between the rotor yoke 4301 and the housing 1401 as shown in FIG. 8 indicate the above case.

Here, as in the first example embodiment and the second example embodiment, a through-hole is provided in the housing 1401, and oil from the second flow path 2 may be discharged to the outside of the housing 1401. In this case, the third flow path may include a flow path positioned outside the housing 1401, that is, a flow path positioned radially outward from the stator 5000 and the rotor 4000. In addition, as in the first example embodiment, the stator 5000 and the rotor 4000 may be an integrally molded article made of a resin, and a groove is provided on the resin. In the case of the integrally molded article made of a resin, it is possible to increase a surface area of the stator 5000 or the rotor 4000 in contact with oil. Therefore, it is possible to cool the inside of the motor unit 2000 more efficiently.

According to the present example embodiment, the pump device 1000 includes the shaft 41 that rotates around the central axis that extends in the axial direction, the motor unit 2000 that rotates the shaft 41, and the pump unit 300 that is positioned on one side of the motor unit 2000 in the axial direction, is driven by the motor unit 2000 via the shaft 41, and discharges oil. The motor unit 2000 includes the rotor 4000 that rotates around the shaft 41, the stator 5000 that is disposed to face the rotor 4000, and the housing 1401 in which the rotor 4000 and the stator 5000 are accommodated. The pump unit 300 includes the pump rotor 351 attached to the shaft 41 and pump cases 311 and 321 in which the suction port 32c into which oil is sucked and the discharge port 32d from which oil is discharged are provided, and the pump rotor 351 is accommodated. The pump device 1000 includes the first oil flow path 1 connecting the inside of the pump unit 300 and the inside of the housing 1401, the second oil flow path 2 provided between the stator 5000 and the rotor 4000, and third flow paths including the flow paths 3a and 3b connected to the second flow path 2 through the inner side of the stator 5000 and the rotor 4000 in the radial direction from the first flow path 1, and the flow path 3c connected to the pump suction port from the second flow path 2. One or a plurality of grooves 55 are provided on the inner peripheral surface of the rotor 4000 or the outer peripheral surface of the stator 5000, and the groove 55 is inclined with respect to the oil flow direction.

The pump device 1000 allows oil to flow into the motor unit 2000 using pressurization by the pump rotor 351. Here, the groove 55 inclined with respect to the oil flow direction is provided between the stator 5000 and the rotor 4000 in which the second flow path is provided, that is, on the inner peripheral surface of the rotor 4000 or the outer peripheral surface of the stator 5000. Therefore, it is possible to efficiently circulate oil. When oil efficiently circulates in the motor unit 2000, it is possible to prevent generation of heat in the rotor magnet 4401 and it is possible to prevent demagnetization. In addition, it is possible to provide a structure in which the rotor 4000 and the stator 5000 are cooled at the same time. That is, That is, it is possible to provide a structure having an excellent cooling effect for preventing the temperature of the motor unit 2000 from increasing.

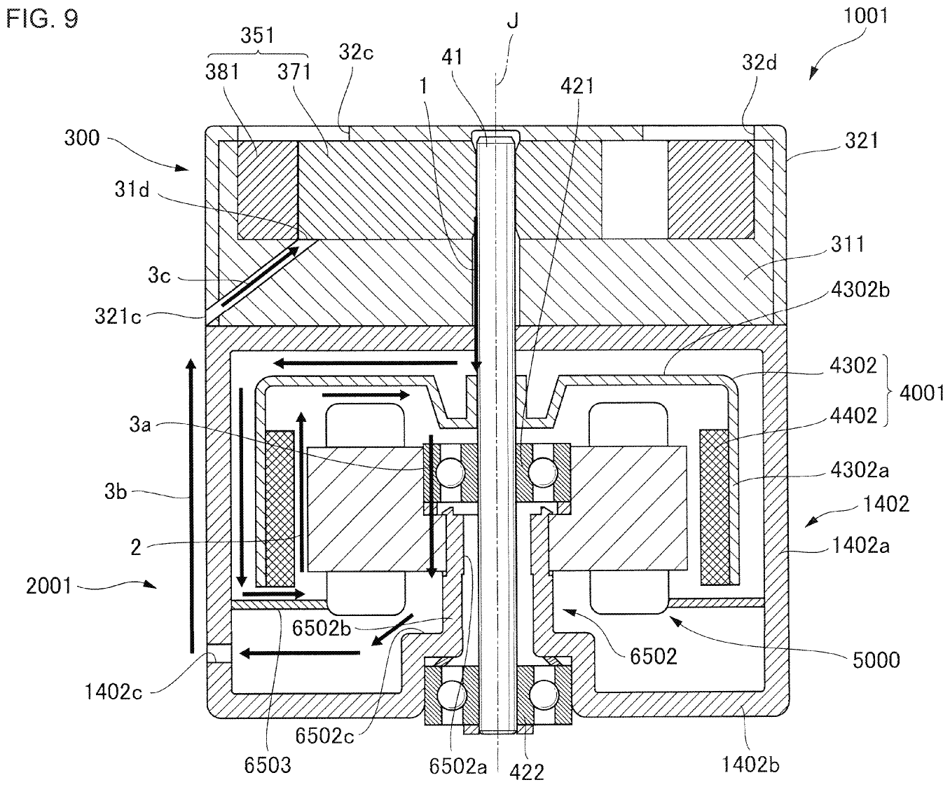

FIG. 9 is a cross-sectional view of another pump device 1001 according to the present example embodiment.

The pump device 1001 of the present example embodiment includes the shaft 41, the motor unit 2001, and the pump unit 300. The shaft 41 rotates around the central axis J that extends in the axial direction. The motor unit 2001 and the pump unit 300 are provided in the axial direction side by side.

The motor unit is different between the pump device 1000 shown in FIG. 8 and the pump device 1001 shown in FIG. 9. Components the same as those in FIG. 8 are denoted with the same reference numerals and descriptions thereof will be omitted. As shown in FIG. 9, the motor unit 2001 includes a housing 1402, a rotor 4001, the stator 5000, a bearing housing 6502, the upper bearing member 421, the lower bearing member 422, a control device (not shown), and a bus bar assembly (not shown). Here, the control device and the bus bar assembly need not to be built into the motor unit 2001, and may be, for example, attached to the rear side one end of the housing 1402 in the axial direction or attached to the side surface of the housing 1402.

The rotor 4001 includes a rotor magnet 4402 and a rotor yoke 4302. Unlike the pump device 1000 in FIG. 8, the rotor yoke 4302 has a cup shape with a rear side opening and includes a disc-shaped top plate part 4302b with the center to which the shaft 41 is connected and a cylindrical part 4302a provided so that the outer periphery of the top plate part 4302b extends toward the rear side. The rotor magnet 4402 is disposed on the inner peripheral surface of the cylindrical part 4302a of the rotor yoke 4302 and the inner peripheral surface thereof aces the stator 5000 in the radial direction. The rotor 4001 is fixed to the shaft 41.

The bearing housing 6502 includes a bearing housing cylindrical part 6502b having a cylindrical shape, an annular protrusion 6502a provided on the inner peripheral surface of the bearing housing cylindrical part 6502b, and a flange part 6502c provided on the outer peripheral surface of the bearing housing cylindrical part 6502b. The annular protrusion 6502a protrudes inward so that the inner diameter of the bearing housing cylindrical part 6502b decreases.

On the inner peripheral surface of the bearing housing cylindrical part 6502b, the lower bearing member 422 is provided on the rear side. On the inner peripheral surface of the bearing housing cylindrical part 6502b, the upper bearing member 421 is provided on the front side. The upper bearing member 421 and the lower bearing member 422 are fitted to the shaft 41. The upper bearing member 421 and the lower bearing member 422 support the shaft 41 so that it is rotatable with respect to the bearing housing 6502.

The stator 5000 is fixed to the outer periphery of the bearing housing 6502. Specifically, the bearing housing 6502 is fitted into the inner peripheral surface of an annular core back part (not shown) of the stator 5000. A bottom wall 1402b of the housing 1402 is disposed on the rear side of the stator 5000 and supports the bearing housing 6502. The control device (not shown) is disposed between the bottom wall 1402b of the housing 1402 and the stator 5000.

Next, a cooling structure of the pump device 1001 according to the present example embodiment will be described. Parts different from those in FIG. 8 will be mainly described. As shown in FIG. 9, the pump device 1001 includes the first flow path 1 connecting the inside of the pump unit 300 and the inside of the housing 1402, the second flow path 2 provided between the stator 5000 and the rotor 4001, and the third flow paths 3a to 3c (third flow path) connected to the suction port (pump suction port) 32c of the pump unit 300 through the inside of the stator 5000 and the rotor 4001 in the radial direction and the outside thereof in the radial direction from the second flow path 2.

In the present example embodiment, oil flowing from the first flow path 1 into the motor unit 2001 flows along the top plate part 4302b of the rotor yoke 4302 and flows between the cylindrical part 4302a and a side surface 1402a of the housing 1402. In the present example embodiment, a ring member 6503 connecting the rear side coil end of the stator 5000 and a side surface of the housing 1402 is provided. Accordingly, oil flowing between the cylindrical part 4302a of the rotor yoke 4302 and the side surface 1402a of the housing 1402 flows through the second flow path 2 provided between the stator 5000 and the rotor 4001.

In the present example embodiment, one or a plurality of grooves 55 are provided on the outer peripheral surface of the stator 5000 or the inner peripheral surface of the rotor 4001. As in the first example embodiment, as shown in FIG. 3A, the groove 55 is inclined with respect to the oil flow direction on the outer peripheral surface of the stator 5000 or on the inner peripheral surface of the rotor 4001. In addition, as in the first example embodiment, as shown in FIG. 3D or FIG. 3E, the groove 55 may have the intermittent part 56 that protrudes in a radially outward direction or in a radially inward direction. In addition, since the shape of the groove 55 and the like are the same as those in the first example embodiment, description thereof will be omitted.

In the present example embodiment, the third flow paths 3a and 3b are flow paths connected to the suction port (pump suction port) 32c of the pump unit 300 through the inside of the stator 5000 and the rotor 4001 in the radial direction and the outside thereof in the radial direction from the second flow path 2, and include the third flow paths 3a to 3c in the example shown in FIG. 9. The third flow path 3a is provided between the stator 5000 and the shaft 41. That is, the third flow path 3a is positioned radially inward from the stator 5000 and the rotor 4001.

The third flow path 3b is provided outside the housing 1402 via a through-hole 1402c provided on the side surface 1402a of the housing. Like the case described with reference to FIG. 6 in the first example embodiment, the flow path provided outside the housing 1402a may include an arbitrary flow path connecting the through-hole 1402c and a through-hole 321c.

In addition, the positions of the through-hole 1402c and the through-hole 321c are not limited to the positions shown in FIG. 9, and they may be provided at arbitrary positions on the side surface 1402a of the housing 1402 or the pump cover 321. The third flow path 3c is provided in the pump body 311 and connects the through-hole 321c and the inside of the pump unit 300. When the third flow path 3c is provided, oil sucked into the motor unit 2001 through the first flow path 1 can circulate from the inside of the motor unit 2001 to the inside of the pump unit 300.

Accordingly, it is possible to efficiently cool the stator 5000 and the rotor 4001. Here, in the example shown in FIG. 9, the third flow path 3c is provided in the pump body 311, but the present disclosure is not limited thereto. The third flow path 3c may include an arbitrary flow path outside the pump device 1001 as long as it is a flow path connected to the pump suction port from the third flow path 3b.

According to the present example embodiment, as in the first example embodiment and the second example embodiment, the pump device 1001 has a structure having an excellent cooling effect in which the stator 5000 and the rotor 4001 are cooled at the same time. Here, as in the first example embodiment, the stator 5000 and the rotor 4001 may be an integrally molded article made of a resin, and a groove is provided on the resin. In the case of the integrally molded article made of a resin, it is possible to increase a surface area of the stator 5000 or the rotor 4001 in contact with oil. Therefore, it is possible to cool the inside of the motor unit 2001 more efficiently.

According to the present example embodiment, the pump device 1001 includes the shaft 41 that rotates around the central axis that extends in the axial direction, the motor unit 2001 that rotates the shaft 41, and the pump unit 300 that is positioned on one side of the motor unit 2001 in the axial direction, is driven by the motor unit 2001 via the shaft 41, and discharges oil. The motor unit 2001 includes the rotor 4001 that rotates around the shaft 41, the stator 5000 that is disposed to face the rotor 4001, and the housing 1402 in which the rotor 4001 and the stator 5000 are accommodated. The pump unit 300 includes the pump rotor 351 attached to the shaft 41, and pump cases 311 and 321 in which the suction port 32c into which oil is sucked and the discharge port 32d from which oil is discharged are provided and the pump rotor 351 is accommodated. The pump device 1001 includes the first oil flow path 1 connecting the inside of the pump unit 300 and the inside of the housing 1402, the second oil flow path 2 provided between the stator 5000 and the rotor 4001, and the third oil flow paths 3a to 3c connected to the suction port 32c of the pump unit 300 through the inside of the stator 5000 and the rotor 4001 in the radial direction and the inside thereof in the radial direction from the second flow path 2. One or a plurality of grooves 55 are provided on the inner peripheral surface of the rotor 4001 or the outer peripheral surface of the stator 5000, and the groove 55 is inclined with respect to the oil flow direction.

The pump device 1001 allows oil to flow into the motor unit 2001 using pressurization by the pump rotor 351. Here, the groove 55 inclined with respect to the oil flow direction is provided between the stator 5000 and the rotor 4001 in which the second flow path is provided, that is, on the inner peripheral surface of the rotor 4001 or on the outer peripheral surface of the stator 5000. Therefore, it is possible to efficiently circulate oil. When oil efficiently circulates in the motor unit 2001, it is possible to prevent generation of heat in the rotor magnet 4402 and it is possible to prevent demagnetization. In addition, the pump device 1001 can provide a structure in which the rotor 4001 and the stator 5000 are cooled at the same time. That is, the pump device 1001 can provide a structure having an excellent cooling effect for preventing the temperature of the motor unit 2001 from increasing.

While example embodiments of the present disclosure have been described above, the present disclosure is not limited to these example embodiments, and various modifications and changes can be made within the spirit and scope of the disclosure.

Priority is claimed on Japanese Patent Application No. 2016-195276, filed Sep. 30, 2016, the content of which is incorporated herein by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-20. (canceled)

21. A pump device comprising:
a shaft that rotates around a central axis that extends in an axial direction;
a motor that rotates the shaft; and
a pump that is positioned on one side of the motor in the axial direction, is driven by the motor via the shaft, and discharges oil; wherein
the motor includes:
a rotor that rotates around the shaft;
a stator facing the rotor; and
a housing in which the rotor and the stator are accommodated;
the pump includes:
a pump rotor that is attached to the shaft; and
a pump case in which a suction port into which the oil is sucked and a discharge port from which the oil is discharged are provided and the pump rotor is accommodated;
the pump device further comprises:
a first flow path for the oil that connects an interior of the pump and an interior of the housing;
a second flow path for the oil provided between the stator and the rotor; and
a third flow path for the oil that is connected to a pump suction port through an outside of the stator and the rotor in a radial direction from the second flow path;
at least one groove is provided on an inner peripheral surface of the rotor and the stator disposed in a radially outward direction or on an outer peripheral surface of the rotor and the stator disposed in a radially inward direction; and
the at least one groove is inclined with respect to an oil flow direction.

22. The pump device according to claim 21, wherein the at least one groove includes a spiral groove.

23. The pump device according to claim 21, wherein the at least one groove includes a plurality of grooves, and each of the plurality of grooves is an annular groove extending around one circumference of a circumferential surface in which the groove is provided, and the plurality of grooves are provided in the axial direction.

24. The pump device according to claim 21, wherein
an intermittent portion that protrudes from the at least one groove in the radial direction is provided on a circumferential surface in which the at least one groove is provided; and
the intermittent portion extends in the axial direction.

25. The pump device according to claim 21, wherein
an intermittent portion that protrudes from the at least one groove in the radial direction is provided on a circumferential surface in which the at least one groove is provided; and
the intermittent portion extends in a circumferential direction.

26. The pump device according to claim 21, wherein
the pump case includes a pump cover and a pump body;
the pump body is open at both ends in the axial direction and the shaft passes therethrough; and
the pump rotor rotates according to rotation of the shaft.

27. The pump device according to claim 26, wherein the stator and the pump body are capable of contacting each other.

28. The pump device according to claim 21, wherein the stator is an integrally molded article made of a resin.

29. The pump device according to claim 28, wherein the stator has the at least one groove included in the resin.

30. The pump device according to claim 21, wherein the rotor is an integrally molded article made of a resin.

31. The pump device according to claim 30, wherein the rotor has the at least one groove included in the resin.

32. The pump device according to claim 21, wherein
the stator is positioned radially outward from the rotor; and
the third flow path includes a flow path connected to the pump suction port through the outside of the stator in the radial direction from the second flow path.

33. The pump device according to claim 32, wherein the third flow path includes a space between the outer peripheral surface of the stator and the inner peripheral surface of the housing of the motor.

34. The pump device according to claim 33, wherein the third flow path includes a through-hole or a cutout provided in the stator or in the housing.

35. The pump device according to claim 32, wherein
one end on a side of the motor of the first flow path is provided at or adjacent to a side of the motor of an opening through which the shaft passes in the pump case; and
the second flow path is connected to one end on a side of the motor of the first flow path.

36. The pump device according to claim 32, further comprising a flow path that is provided between the outer peripheral surface of the shaft and the inner peripheral surface of the rotor.

37. The pump device according to claim 32, further comprising a flow path through which a through-hole provided in the rotor passes.

38. A pump device comprising:
a shaft that rotates around a central axis that extends in an axial direction;
a motor that rotates the shaft; and
a pump that is positioned on one side of the motor in the axial direction, is driven by the motor via the shaft, and discharges oil; wherein
the motor includes:
a rotor that rotates around the shaft;
a stator that faces an inner side of the rotor in a radial direction;
a housing in which the rotor and the stator are accommodated;
the pump includes:
a pump rotor that is attached to the shaft; and
a pump case in which a suction port into which the oil is sucked and a discharge port from which the oil is discharged are provided and the pump rotor is accommodated;
the pump device further comprises:
a first flow path for the oil that connects an interior of the pump and an interior of the housing;
a second flow path for the oil provided between the stator and the rotor; and
a third flow path for the oil including a flow path connected to the second flow path through an interior of the stator and the rotor in the radial direction from the first flow path and a flow path connected to a pump suction port from the second flow path; wherein
at least one groove is provided on an inner peripheral surface of the rotor and the stator disposed in a radially outward direction or on an outer peripheral surface of the rotor and the stator disposed in a radially inward direction; and
the at least one groove is inclined with respect to an oil flow direction.

39. A pump device comprising:
a shaft that rotates around a central axis that extends in an axial direction;
a motor that rotates the shaft; and
a pump that is positioned on one side of the motor in the axial direction, is driven by the motor via the shaft, and discharges oil; wherein
the motor includes:
a rotor that rotates around the shaft;
a stator that faces the rotor in the axial direction; and
a housing in which the rotor and the stator are accommodated;
the pump includes:
a pump rotor that is attached to the shaft; and
a pump case in which a suction port into which the oil is sucked and a discharge port from which the oil is discharged are provided and the pump rotor is accommodated;
the pump device further comprises:
a first flow path for the oil that connects an interior of the pump and an interior of the housing;
a second flow path for the oil provided between the stator and the rotor; and
a third flow path for the oil that is connected to a pump suction port through an outside of the stator and the rotor in a radial direction from the second flow path;
at least one groove is provided on a facing surface in which the rotor and the stator face each other; and
the at least one groove is inclined with respect to an oil flow direction.

40. The pump device according to claim 39, wherein
the motor includes two rotors attached to the shaft with a predetermined interval therebetween in the axial direction;
the stator is disposed between the two rotors; and
the second flow path includes a flow path provided between a first of the two rotors and the stator, and a flow path provided between a second of the two rotors and the stator.
